(19) United States
(12) Patent Application Publication
(10) Pub. No.: US 2026/0289139 A1
(43) Pub. Date: Sep. 24, 2026

(54) SYSTEM

(71) Applicant: SoftBank Group Corp., Tokyo (JP)

(72) Inventor: Amane ORITO, Tokyo (JP)

(73) Assignee: SoftBank Group Corp., Tokyo (JP)

(21) Appl. No.: 19/568,803

(22) Filed: Mar. 17, 2026

(30) Foreign Application Priority Data
Mar. 19, 2025 (JP) 2025-045216

(51) Int. Cl. G06F 40/30; G06F 40/268; G10L 25/63

(52) U.S. Cl. CPC G06F 40/30; G06F 40/268; G10L 25/63

(57) ABSTRACT

A system includes a processor that is configured to receive an inquiry from a user and analyze contents of the inquiry by using a natural language processing technique, automatically classify the inquiry into an appropriate service or department based on an analysis result of the inquiry, generate a prompt for instructing a generative AI model to generate an answer to the inquiry, input the prompt to the generative AI model, and provide a generated answer from the generative AI model to the user.

### CROSS-REFERENCE TO RELATED APPLICATION

This application is based on and claims priority under 35 USC 119 from Japanese Patent Application No. 2025-045216 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional inquiry handling systems typically require manual triage by human operators or rely on simple rule-based routing, which leads to delays, inconsistent classification of inquiries, and high operational costs. When generative AI models are used, they are often invoked in an ad hoc manner without systematic integration of natural language understanding, so that inquiries may be misinterpreted or routed to unsuitable services or departments. Furthermore, existing systems rarely adapt answers to the emotional state of the user, which can result in user dissatisfaction, especially in situations involving complaints or urgent issues. In addition, when generative AI models produce answers, there is a risk that the answers will not conform to official manuals or internal knowledge resources, thereby causing inaccurate or non-compliant responses. Accordingly, there is a need for a system that can accurately analyze user inquiries, automatically classify them to appropriate services or departments, generate answers through a generative AI model, adjust the answers according to the user's emotion, and ensure that the generated answers comply with manuals or knowledge resources.

### SUMMARY

In order to solve the above-described problems, a system is provided comprising a processor, wherein the processor is configured to receive an inquiry from a user and analyze contents of the inquiry by using a natural language processing technique, automatically classify the inquiry into an appropriate service or department based on an analysis result of the inquiry, and generate a prompt for instructing a generative AI model to generate an answer to the inquiry, input the prompt to the generative AI model, and provide a generated answer from the generative AI model to the user. The processor is further configured to analyze an emotion of the user and adjust the answer based on the emotion of the user, for example by modifying wording, tone, or level of detail according to a detected emotional state. The processor is also configured to verify that the generated answer complies with a manual or a knowledge resource by comparing the generated answer with stored manuals or knowledge bases and, when necessary, correcting or supplementing the generated answer based on such manuals or knowledge resources. In this manner, the system enables consistent automatic routing of inquiries, emotionally appropriate responses, and generation of answers that are aligned with authorized documentation.

The term “system” refers to a combination of hardware and/or software components, including at least one processor and associated memory and interfaces, that cooperatively perform the functions described in the claims.

The term “processor” refers to any hardware device or combination of devices capable of executing instructions, including but not limited to a central processing unit (CPU), a graphics processing unit (GPU), a digital signal processor (DSP), a microcontroller, or a plurality of such units operating together.

The term “inquiry” refers to any information, question, request, complaint, or message submitted by a user to the system in natural language or a similar textual or spoken form, which is to be processed and answered by the system.

The term “user” refers to any human or external entity that interacts with the system by submitting an inquiry and receiving an answer, including customers, operators, or system administrators.

The term “natural language processing technique” refers to any computational method or algorithm for analyzing, understanding, or processing human language, including but not limited to tokenization, morphological analysis, syntactic parsing, semantic analysis, intent detection, and entity recognition.

The term “analysis result” refers to information obtained by the processor through applying a natural language processing technique to the inquiry, including, for example, detected intents, extracted entities, inferred topics, or classifications.

The term “service or department” refers to a logical or organizational destination to which an inquiry can be assigned, such as a customer support function, a technical support group, a sales department, or an automated service module.

The term “automatically classify” refers to a process in which the processor, without manual intervention, determines an appropriate service or department for an inquiry based on the analysis result, using predefined rules, machine learning models, or other decision logic.

The term “generative AI model” refers to a machine learning model, such as a large language model or similar generative model, that is capable of generating natural language text as an answer based on an input prompt.

The term “prompt” refers to data provided as input to the generative AI model, including at least information representing the inquiry and optionally additional instructions, constraints, or context, for causing the generative AI model to generate an answer.

The term “answer” refers to a response in natural language text generated by the generative AI model, optionally after adjustment or verification by the processor, that is intended to address the contents of the inquiry.

The term “emotion of the user” refers to an affective state inferred from the inquiry or related interaction data, including but not limited to emotions such as satisfaction, frustration, anger, confusion, or urgency.

The term “adjust the answer” refers to modifying at least part of the generated answer, including, for example, changing wording, tone, politeness, length, structure, or level of detail, based on the analyzed emotion of the user.

The term “manual” refers to any official document that describes procedures, specifications, handling methods, operational steps, or policies, including but not limited to product manuals, operation manuals, and service guidelines.

The term “knowledge resource” refers to any structured or unstructured collection of information used as an authoritative reference by the system, including but not limited to knowledge bases, FAQ documents, internal guidelines, and technical documentation.

The term “verify that the generated answer complies” refers to checking, by the processor, whether the contents of the generated answer are consistent with information contained in at least one manual or knowledge resource, and optionally correcting, rejecting, or supplementing the generated answer based on such information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

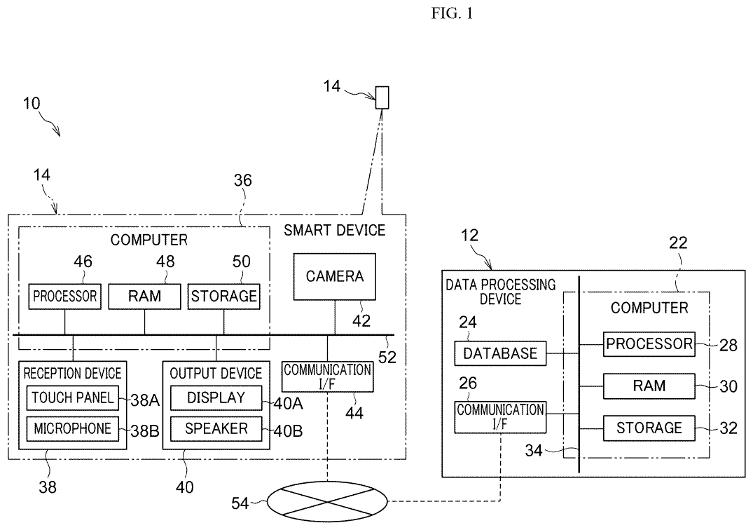

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

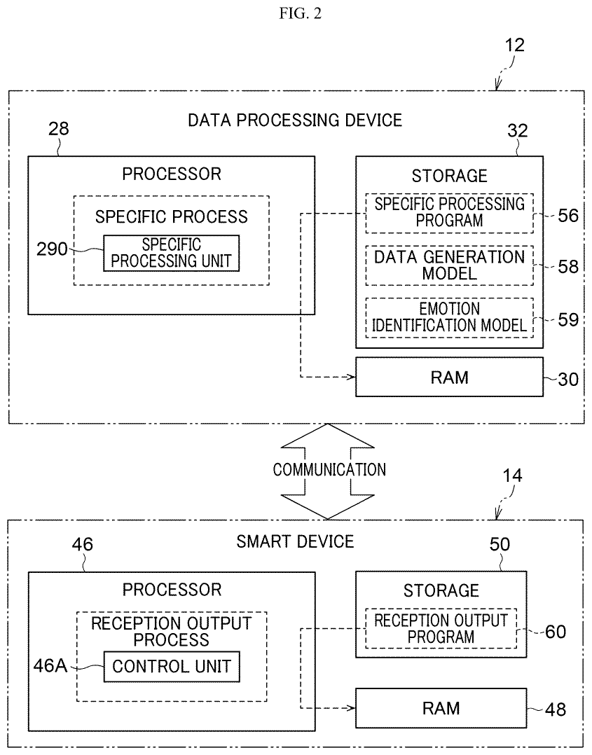

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that generate responses to user inquiries using natural language processing and machine learning often suffer from several technical deficiencies at the computing-system level. First, a processor in such systems typically forwards the raw user query text directly to a generative AI model or applies only minimal preprocessing. As a result, the system fails to represent the user's intent and context in a structured manner that is optimized for the generative AI model, which leads to unstable output quality, unnecessary token usage, and increased computational load on external model-serving infrastructure. This degrades throughput and increases latency, particularly when many terminals concurrently issue inquiries over a communication network. Second, in many systems, the processor does not systematically construct prompt sentences based on an explicit classification of inquiry type and processing domain, nor does it consistently incorporate document information, explanatory materials, or rule information as context. Instead, context is often appended in an ad hoc fashion, if at all. This causes the generative AI model to repeatedly generate responses that are not aligned with internal manuals or rule documents, which in turn requires expensive post-hoc human correction and manual verification. From a computer-technology standpoint, this leads to inefficient use of storage, network bandwidth, and processing resources, because the same or similar knowledge sources must be reprocessed or rechecked outside of an integrated pipeline. Third, typical systems lack a robust mechanism for dynamically tailoring prompt sentences to user-specific characteristics, such as past operation history, previous inquiries, or preferred language and detail level. Without this adaptive control at the prompt construction stage, the generative AI model often produces responses that are mismatched to the user's comprehension level or interaction style. This mismatch results in additional network round trips and repeated inference calls to clarify or rephrase answers, which increases overall resource consumption in terms of CPU cycles, memory usage, and network traffic on both the server side and the generative AI model provider side.

Fourth, many existing architectures do not tightly couple generated answers with the underlying source materials that were used by the system during generation. Identification information of documents, explanatory materials, or rule information is not persistently associated with the final answers. Consequently, the system cannot efficiently trace back which stored data supported which output, making it difficult to implement automated verification, auditing, or debugging routines. This lack of traceability forces human operators or external tools to perform redundant searches over large data stores, thereby increasing the computational burden and response time when validating or reproducing system behavior. Accordingly, there is a need for a computer-implemented system and server-side processing architecture that: (i) systematically analyzes inquiry information using natural language processing to extract purpose and attribute information; (ii) identifies inquiry type and processing domain; (iii) constructs optimized prompt sentences and context packages for a generative AI model; (iv) adapts the generated response style based on user characteristic information; and (v) associates final answers with identification information of knowledge sources. By integrating these functions into a coordinated processing pipeline executed by a processor, the system can improve the efficiency and reliability of inquiry handling at the computing-technology level, reduce the computational load on external generative AI infrastructure, and enhance the overall performance of the server and communication network.

The specific processing by the specific processing unit 290 of the data processing device 12 in Example 1 is realized by the following means.

The present invention provides a server comprising a processor and a memory storing instructions that, when executed by the processor, cause the processor to receive inquiry information input by a user via a communication terminal through a communication network and store the inquiry information as character information; perform language analysis processing on the character information by using natural language processing resources, the language analysis processing including morphological analysis, syntactic analysis, and semantic analysis, to extract purpose information and attribute information related to the inquiry information, and to identify an inquiry type and a processing domain based on the purpose information and the attribute information; acquire, from a storage device, template information among a plurality of pieces of template information associated with the identified inquiry type and the processing domain, and embed the inquiry information and at least one of the extracted purpose information and the extracted attribute information into the template information to construct a prompt sentence for input to a generative AI model; add, to the prompt sentence, context information including related text information extracted from at least one of document information, explanatory material, and rule information stored in a recording medium, and generate inquiry data including the prompt sentence and the context information as input information to be supplied to the generative AI model; transmit the inquiry data as a communication request to an external generative AI model providing apparatus and receive answer candidate information output as a response from the generative AI model providing apparatus; execute post-processing on the answer candidate information, the post-processing including at least one of deleting unnecessary information, formatting an expression style, and filtering prohibited terms, to generate final answer information corresponding to the inquiry information; transmit the final answer information as response data to the communication terminal through the communication network and control display of the final answer information on the communication terminal; acquire user characteristic information from the storage device based on operation history information of the user and past inquiry information of the user, and add instruction information indicating at least one of an answer style, a detail level, and a use language corresponding to the user characteristic information to the prompt sentence to adjust an expression of a generated answer by the generative AI model; and associate identification information of at least one of the document information, the explanatory material, and the rule information used for generation of the answer candidate information with the final answer information and record the final answer information in association with the identification information to enable tracking of basis information referenced by the final answer information. This enables improvement of computer technology by optimizing prompt sentence construction and contextual input for the generative AI model, reducing redundant processing and network traffic through adaptive response generation based on user characteristics, and enhancing system-level reliability and auditability through persistent association between final answers and underlying knowledge sources.

The term “processor” refers to a hardware computation unit, such as a central processing unit or a processing circuit, that executes instructions to perform arithmetic, logical, control, and input/output operations.

The term “memory” refers to a hardware storage resource, such as a volatile memory or a non-volatile memory, that stores instructions and data to be accessed by the processor.

The term “instructions” refers to machine-executable commands, program codes, or software modules that define processing operations to be performed by the processor.

The term “communication terminal” refers to an electronic device, such as a portable terminal, a personal computer, or a network-connected display device, that enables a user to input inquiry information and receive response information via a communication network.

The term “communication network” refers to a wired or wireless data transmission infrastructure, such as a local area network, a wide area network, or the Internet, that enables data exchange between the server and the communication terminal or between the server and an external apparatus.

The term “inquiry information” refers to information representing a question, request, or instruction input by a user, typically expressed in a natural language string, and transmitted from the communication terminal to the server.

The term “character information” refers to textual data in which the inquiry information or other content is represented as a sequence of characters encoded in a predetermined character set.

The term “natural language processing resources” refers to software components, libraries, or models that perform automatic analysis of natural language text, including but not limited to tokenization, part-of-speech tagging, syntactic parsing, semantic analysis, and entity recognition.

The term “language analysis processing” refers to a series of operations executed on character information using natural language processing resources to interpret the structure and meaning of the text, including at least morphological analysis, syntactic analysis, and semantic analysis.

The term “morphological analysis” refers to a processing step that segments a text into minimal linguistic units, such as words or morphemes, and assigns grammatical attributes to each unit.

The term “syntactic analysis” refers to a processing step that identifies grammatical relationships between words or phrases in a text to derive a syntactic structure such as a parse tree or dependency graph.

The term “semantic analysis” refers to a processing step that interprets the meaning of words, phrases, and sentences in context to extract semantic roles, intentions, or relationships.

The term “purpose information” refers to information representing an intended goal, objective, or task implied by the inquiry information, such as requesting an explanation, asking for a status, or requesting a summary.

The term “attribute information” refers to information representing additional characteristics, constraints, or parameters related to the inquiry information, such as a target object, a time range, a location, or a desired output format.

The term “inquiry type” refers to a classification category that indicates a general kind of processing associated with the inquiry information, such as a question type, a request type, or a command type.

The term “processing domain” refers to a classification category that indicates a technical or functional area to which the inquiry information pertains, such as weather information, product documentation, policy rules, or troubleshooting support.

The term “template information” refers to structured data representing a sentence pattern, format, or skeleton text in which variable portions can be replaced by inquiry information, purpose information, or attribute information to construct a complete prompt sentence.

The term “prompt sentence” refers to a text string formatted as an instruction or input message to be supplied to a generative AI model, the text string being constructed by embedding analysis results and other information into template information.

The term “generative AI model” refers to a machine learning model that generates natural language output text based on input text, the model being configured to perform probabilistic prediction of token sequences or similar generative operations.

The term “context information” refers to supplemental text data, including related text information derived from document information, explanatory material, or rule information, that is added to the prompt sentence to provide background knowledge or constraints to the generative AI model.

The term “document information” refers to stored text data or document-like content, such as manuals, guides, or reference materials, that can be used as a knowledge source for generating responses.

The term “explanatory material” refers to stored content, such as explanation texts, tutorials, help documents, or usage notes, that provide clarifications or instructions related to a subject.

The term “rule information” refers to stored content describing rules, policies, regulations, or procedures that should be followed or reflected in a generated answer.

The term “recording medium” refers to a physical or logical storage medium, such as a semiconductor memory, a magnetic disk, or an optical disk, that retains document information, explanatory material, or rule information.

The term “inquiry data” refers to a data structure including at least a prompt sentence and context information, the data structure being transmitted from the server to the generative AI model as input information.

The term “generative AI model providing apparatus” refers to an external computing system or service that hosts and executes a generative AI model, receives inquiry data from the server, and outputs generated answer candidate information.

The term “answer candidate information” refers to text data or structured data output from the generative AI model providing apparatus in response to inquiry data, the text data representing one or more candidate answers to the inquiry information.

The term “post-processing” refers to processing applied to answer candidate information after reception from the generative AI model, including at least deleting unnecessary information, formatting an expression style, and filtering prohibited terms, to produce final answer information.

The term “final answer information” refers to response data generated by applying post-processing to answer candidate information, the response data being determined to correspond to the inquiry information and intended for presentation to the user.

The term “response data” refers to data containing final answer information and optionally additional metadata, the data being transmitted from the server to the communication terminal through the communication network.

The term “user characteristic information” refers to information derived from at least operation history information and past inquiry information of a user, representing preferences, behavioral patterns, or profile attributes used to control response generation.

The term “operation history information” refers to stored data representing past user operations on the communication terminal or the system, such as input logs, selection histories, or interaction patterns.

The term “past inquiry information” refers to stored data representing prior inquiries made by the user, including the contents of previous questions and associated system responses.

The term “instruction information” refers to information embedded in the prompt sentence that indicates constraints or preferences for a generated answer, such as an answer style, a detail level, or a use language.

The term “answer style” refers to characteristics of the expression of a generated answer, such as formality, tone, structure, or degree of technicality.

The term “detail level” refers to a degree of specificity or conciseness required for a generated answer, such as a brief summary or a detailed explanation.

The term “use language” refers to a target natural language or dialect in which the generative AI model is instructed to output the generated answer.

The term “identification information” refers to data that uniquely or specifically identifies document information, explanatory material, or rule information, such as an identifier, path, index, or reference key.

The term “basis information” refers to underlying knowledge sources, including document information, explanatory material, and rule information, that are referenced or used, directly or indirectly, in generating answer candidate information or final answer information.

In one embodiment, the server is implemented as an information processing apparatus including at least one processor, a main memory, a non-volatile storage device, and a network interface. The server uses a general-purpose operating system, such as a server-class operating system, and executes an application program implemented, for example, in an interpreted language runtime such as a Python environment. The server stores natural language processing libraries, such as a tokenization and parsing library and a semantic analysis library, and communicates with an external generative AI model providing apparatus through an HTTP-based application programming interface.

The terminal is implemented as a communication device, such as a smartphone, a tablet, or a personal computer, including a processor, a memory, a display device, an input device, and a wireless or wired communication interface. The terminal executes an application, such as a web client or a native chat client, that provides a graphical user interface. The terminal allows the user to enter an inquiry, displays response information received from the server, and transmits and receives structured messages to and from the server over a communication network.

The user operates the terminal by viewing a chat-style screen and entering natural language questions in a text input area. The user does not directly access the external generative AI model. Instead, the user relies on the terminal and the server to mediate all communication with the external generative AI model providing apparatus.

The server uses a modular software architecture including, for example, a request reception module, a natural language analysis module, a classification and routing module, a prompt construction module, a context retrieval module, a generative AI interface module, a post-processing module, and a logging and traceability module. The server stores configuration data, template data, and user profile data in a structured storage, such as a relational database or a key-value store. The server uses data structures such as JSON-like objects, dictionaries, and arrays to represent inquiry information, analysis results, prompt sentences, and generated answer candidate information.

The server uses a natural language analysis module to process character information representing the inquiry. The server loads a pre-trained linguistic model from a natural language processing library, such as a tokenization and syntactic parsing model. The server applies morphological analysis to split the inquiry into words or morphemes. The server applies syntactic analysis to build dependency structures between tokens. The server applies semantic analysis to detect intent phrases, argument roles, named entities, and temporal or spatial modifiers. For example, when the user asks “What is the weather today?”, the server identifies an intent of “obtain current weather information” and an attribute of “time =today.”

The server uses a classification and routing module to map the extracted purpose information and attribute information to a discrete inquiry type and a processing domain. The server may use a trained multi-class classifier, such as a feedforward neural network or a gradient boosting model, to transform features derived from the linguistic analysis into an inquiry type label and a processing domain label. The server constructs feature vectors that include, for example, bag-of-words features, part-of-speech tag statistics, and semantic embeddings of the inquiry text. The server stores the classifier parameters in the memory and executes them deterministically on the processor. By performing this classification on the server, the system avoids sending raw, unstructured text to the generative AI model and thereby reduces redundant computation on the external generative AI infrastructure.

The server uses a prompt construction module to generate a prompt sentence adapted to the identified inquiry type and processing domain. The server stores multiple template patterns in the storage device. Each template pattern includes fixed segments and variable segments. The server fills the variable segments with the original inquiry, the purpose information, and the attribute information. The server thereby transforms short or ambiguous user questions into prompt sentences that explicitly state the task, constraints, and expected output style.

For example, the server constructs a prompt sentence such as:
“The user asked the following question: ‘What is the weather today?’. Based on this question, please provide the current weather information in a concise sentence.”

In another example related to policy documents, the server constructs a prompt sentence such as:
“Using the following policy text as context, answer the user's question clearly and accurately. Context: [policy text]. User's question: [user question].”

In a further example related to FAQs, the server constructs a prompt sentence such as:
“From the FAQ entries listed in the context, generate the best possible answer to the user's query. Context: [FAQ entries]. User's query: [user query].”

The server uses a context retrieval module to obtain relevant background data from document information, explanatory materials, or rule information stored in the storage device. The server stores such information in a structured index, such as an inverted index or a vector index. The server converts documents into token sequences and then into vector representations using, for example, a sentence embedding model or a term-frequency inverse-document-frequency representation. The server maintains a data structure that maps document identifiers to embedding vectors. The server computes similarity scores between the inquiry representation and stored document representations using a distance function, such as cosine similarity, and selects top-ranking passages as context information. The server appends selected passages to the prompt sentence to form a combined textual input that consists of a task description, a reference to the user's question, and a compact set of domain-specific passages. By compressing the original documents into only the most relevant passages before sending them to the generative AI model, the server reduces token usage, network bandwidth, and latency, and thus improves computational efficiency at both the server and the external generative AI model providing apparatus.

The server interfaces with a generative AI model providing apparatus that hosts a generative AI model. The generative AI model is implemented as a neural network, such as a transformer-based sequence model, comprising multiple layers of self-attention and feedforward sublayers. The generative AI model uses parameters (weights and biases) that have been pre-trained on a large corpus of text data using a language modeling objective, such as minimizing cross-entropy loss between predicted token distributions and actual tokens. The generative AI model uses an auto-regressive decoding algorithm, such as greedy decoding or beam search, to generate output tokens sequentially given the input prompt sentence and context information.

The server does not directly control the training of the external generative AI model in some embodiments. However, in other embodiments, the server participates in fine-tuning by supplying supervised pairs of input prompt sentences and target answers to adjust the model parameters. The generative AI model updates its weights using an optimization algorithm, such as stochastic gradient descent or Adam, and a loss function, such as cross-entropy over target token sequences. The generative AI model may use regularization techniques, such as dropout, and data augmentation techniques, such as paraphrase generation, to improve generalization. By structuring the input as a prompt sentence with explicit context and task instructions, the server allows the generative AI model to converge more quickly during training and to perform more accurate inference, thereby improving computational efficiency and answer quality.

The server uses a user profile storage to maintain user characteristic information. The server records operation history information, such as past queries, chosen options, and preferred response formats, and past inquiry information, such as question categories and resolutions. The server aggregates this information per user into a user profile record that includes features, such as typical language preference, tolerance for technical jargon, and preferred length of explanations. The server uses such features to generate additional instruction clauses appended to prompt sentences. For instance, the server can add text such as: “Answer in simple terms suitable for a beginner and limit the answer to three sentences.” or “Use technical terminology appropriate for an expert and include detailed reasoning.” The server thereby customizes generated output at the model input level, rather than post-hoc editing large generic outputs. This approach reduces the need for multiple server-to-model exchanges, decreases the number of generated tokens, and optimizes the use of computational time and memory resources. The adjustment of prompt sentences based on user characteristic information results in fewer clarification cycles and fewer redundant computations. The server uses a post-processing module to refine the answer candidate information received from the generative AI model providing apparatus. The server identifies and removes boilerplate phrases or redundant segments by applying pattern matching and heuristic rules, such as detection of repeated sentences or predetermined disclaimers. The server reformats the answer text in accordance with display constraints of the terminal, such as line length limits, and applies filters that replace or mask prohibited terms using a dictionary of disallowed expressions. The server thereby produces final answer information that is consistent with content policies and can be rendered efficiently on the terminal display. The server uses a logging and traceability module to associate final answer information with basis information. The server stores, for each generated answer, identification information of the document information, explanatory material, or rule information used as context. The server records in a storage device a mapping between an answer identifier, the corresponding inquiry identifier, and the identifiers of the underlying knowledge sources. This mapping enables subsequent diagnosis, verification, or re-generation. When the system is audited, the server can automatically retrieve the exact passages that supported a given answer, without dispatching additional large-scale queries to the generative AI model. This traceability reduces the need for repeated expensive model inferences and contributes to lower operational costs and improved technical reliability.

The terminal displays the final answer information on a screen using user interface elements, such as text views or HTML text containers. The terminal may highlight relevant phrases, paginate long answers, or provide controls for collapsing and expanding sections. The terminal may also cache recent answers locally in a memory to reduce network requests when the user wishes to revisit recently viewed content. By performing lightweight rendering and caching at the terminal, the system reduces load on the server and network and improves perceived responsiveness.

The user can employ the system for various technical domains, such as accessing network configuration manuals, troubleshooting device errors, or querying operational rules for machine tools. In such scenarios, the server retrieves context from domain-specific technical documents and rule sets and constructs domain-tailored prompt sentences. The resulting answers often contain actionable sequences, such as configuration steps or diagnostic procedures, which the user can apply to control external equipment. By tightly coupling the content of the answers with structured technical documentation and rules, the system supports reliable machine operation and reduces misconfiguration.

The system improves computer technology in several concrete respects. By performing structured natural language analysis and inquiry classification on the server and by constructing optimized prompt sentences, the system reduces the amount of unstructured data sent to the generative AI model providing apparatus, which reduces network bandwidth consumption and external compute load. By selecting only the most relevant contextual passages through vector similarity search and explicit indexing, the system minimizes token length and accelerates inference time. By tailoring prompts using user characteristic information, the system reduces the need for additional clarifying queries, thereby decreasing total processing cycles and improving throughput. By recording explicit linkages between final answers and basis information, the system enables automated verification workflows that avoid repeated data scanning and repeated model invocation. These technical interactions yield measurable improvements in latency, accuracy, resource utilization, and system reliability, beyond merely automating human reading and writing tasks.

The server can implement alternative embodiments for some components. For example, the natural language analysis module can use a recurrent neural network, such as a bidirectional long short-term memory model, instead of a transformer-based encoder. The classification and routing module can use a rule-based decision tree instead of a statistical classifier, where rules examine specific lexical patterns or entity types. The context retrieval module can use a locality-sensitive hashing index for approximate nearest-neighbor retrieval to further reduce search time. The generative AI interface module can support multiple models with different architectures and can select a model according to domain, latency requirements, or cost constraints. The post-processing module can incorporate a secondary discriminator model that evaluates candidate answers for consistency with rule information before acceptance.

The terminal can also vary in implementation. In one embodiment, the terminal runs a native mobile application that uses a system-level networking library to maintain persistent connections to the server. In another embodiment, the terminal executes a web application in a browser that uses asynchronous HTTP requests to communicate with the server. In yet another embodiment, the terminal is a specialized device with a simplified display that presents answers in a constrained format to operators in an industrial environment. The user can configure preferences that influence server behavior. The user can specify maximum answer length, preferred language, and allowed latency thresholds. The server reads such preferences from the user profile storage and encodes them into instruction clauses in prompt sentences. When a preference conflicts with system-wide constraints, the server resolves such conflicts using predetermined rules, such as prioritizing safety-related rules over stylistic preferences.

By integrating these modules and data flows into a single coordinated architecture, the server cooperates with the terminal and the user to provide an inquiry-response system that leverages a generative AI model in a technically grounded manner. The system does not merely automate existing human tasks; instead, the system reorganizes data structures, controls information flow, and optimizes generative model usage to improve computational efficiency, response accuracy, and manageability of stored knowledge, thereby providing a concrete improvement to computer technology.

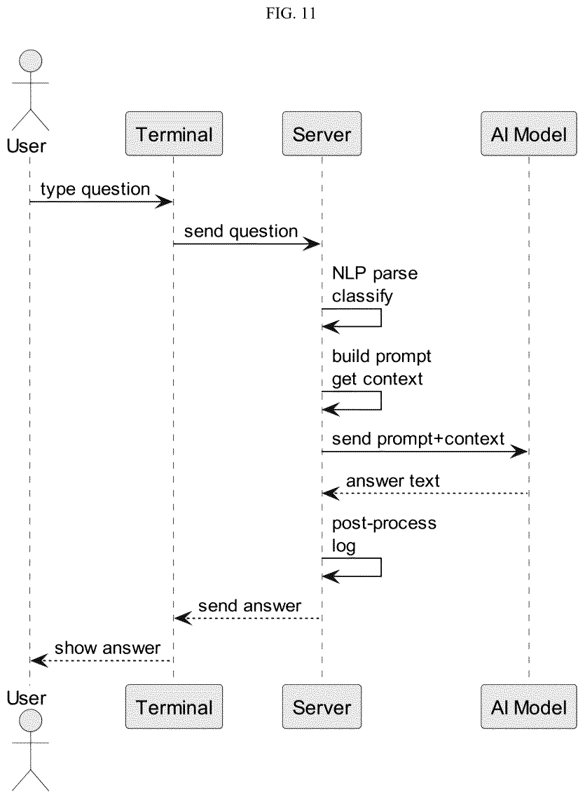

The following describes the processing flow using FIG. 11.
Step 1:

The user operates the terminal to open an application screen that displays a text input field and a send control.

The user enters inquiry text, for example “What is the weather today?”, into the text input field.

The terminal receives key inputs from the user interface, converts the sequence of keystrokes into a Unicode character string, and stores the string temporarily in an input buffer in the terminal memory.

Input: raw keystroke events or touch events generated by the user.

Output: a structured text object representing the inquiry information, such as a Unicode string stored in the terminal application memory.
Step 2:

The terminal constructs a message object that encapsulates the inquiry information, a user identifier, and optional metadata such as a timestamp and language code.

The terminal serializes this message object into a transport format, such as a JSON text, and embeds it into the body of an HTTP request targeted to an endpoint of the server.

The terminal sends the HTTP request to the server through the communication network using a networking stack implemented in the terminal operating system.

Input: the structured text object representing the inquiry information and user metadata.

Output: a network request containing serialized inquiry data transmitted to the server.
Step 3:

The server receives the HTTP request via the network interface and passes the request to a request reception module.

The server parses the request body, decodes the serialized data, and reconstructs an internal data structure that represents the inquiry information and associated metadata.

The server validates the structure, checks that a required field for the inquiry text is present and non-empty, and associates a unique request identifier with the reconstructed data structure.

Input: the serialized inquiry data received over the communication network.

Output: a validated internal inquiry record that includes the inquiry text, user identifier, metadata, and a newly assigned request identifier.
Step 4:

The server forwards the inquiry text from the internal inquiry record to a natural language analysis module.

The server uses a natural language processing library to tokenize the text into a sequence of tokens, perform part-of-speech tagging, and build a syntactic dependency graph. The server applies semantic analysis algorithms to detect intent phrases, entities, and modifiers, and then computes purpose information and attribute information as structured fields (for example, intent=“get_weather”, time=“today”).

Input: the validated internal inquiry record including the inquiry text.

Output: an enriched inquiry record that additionally contains linguistic features, purpose information, and attribute information derived from the text.
Step 5:

The server uses a classification and routing module to determine an inquiry type and a processing domain.

The server constructs a feature vector from the linguistic features, such as counts of key terms, embeddings of the inquiry text, and encoded attribute values.

The server inputs this feature vector into a classifier, for example a trained neural network or another statistical model, and obtains class labels indicating the inquiry type (for example, “information_request”) and the processing domain (for example, “weather”).

Input: the enriched inquiry record including linguistic features and derived purpose and attribute information.

Output: the enriched inquiry record further annotated with an identified inquiry type and a processing domain.
Step 6:

The server passes the annotated inquiry record to a prompt construction module.

The server selects a template pattern corresponding to the identified inquiry type and processing domain from a template repository stored in a storage device.

The server fills placeholders in the template pattern with the inquiry text, the purpose information, and the attribute information to generate a prompt sentence that explicitly describes the task for the generative AI model.

Input: the annotated inquiry record including inquiry type and processing domain.

Output: a prompt sentence string that has been constructed from a template and embedded inquiry-related information.
Step 7:

The server invokes a context retrieval module to obtain background passages from stored document information, explanatory materials, or rule information.

The server computes a vector representation of the inquiry using, for example, a sentence embedding model, and compares this vector with pre-computed document vectors stored in an index.

The server ranks candidate passages by similarity score and selects top-ranking passages as context information that are relevant to the inquiry.

Input: the annotated inquiry record and the prompt sentence, used to derive a query representation.

Output: a set of selected text passages constituting context information to be attached to the prompt sentence.
Step 8:

The server concatenates the prompt sentence and the selected context information in a predefined textual layout to form input content for the generative AI model.

The server creates a data structure, referred to as inquiry data, that includes the combined text, model configuration parameters (such as maximum output length and temperature), and any user-specific instruction clauses.

The server serializes this inquiry data into a request format compatible with the interface of the external generative AI model providing apparatus.

Input: the prompt sentence and the context information.

Output: serialized inquiry data prepared for transmission to the generative AI model providing apparatus.
Step 9:

The server sends the serialized inquiry data to the generative AI model providing apparatus using a secure network protocol, such as HTTPS.

The server records transmission metadata, including request time and model endpoint identifier, in a log associated with the request identifier.

The server then waits for a response from the generative AI model providing apparatus while monitoring timeout conditions and error codes at the communication layer.

Input: the serialized inquiry data and endpoint information for the generative AI model providing apparatus.

Output: a network request dispatched to the generative AI model providing apparatus and a pending state associated with the request identifier.
Step 10:

The server receives, from the generative AI model providing apparatus, a response message that contains generated text representing answer candidate information and additional metadata.

The server deserializes the response, extracts the answer candidate text, and binds this text to the corresponding request identifier in an internal data structure.

The server performs sanity checks, such as verifying that the generated text is non-empty and that required fields are present in the response.

Input: the response message from the generative AI model providing apparatus.

Output: an internal answer candidate record containing the generated text and associated metadata bound to the request identifier.
Step 11:

The server forwards the internal answer candidate record to a post-processing module.

The server applies pattern-matching rules and formatting rules to the candidate text to remove redundant phrases, adjust punctuation, and normalize whitespace.

The server applies a filtering process using a dictionary or rule set to identify and mask prohibited terms or to replace them with allowed alternatives.

Input: the internal answer candidate record containing the generated text.

Output: final answer information that has been cleaned, formatted, and filtered for presentation to the user.
Step 12:

The server uses a logging and traceability mechanism to associate the final answer information with the inquiry record and the identifiers of the context passages used during generation.

The server stores, in a persistent storage device, a record including the inquiry text, the final answer information, the list of document identifiers used as context, and timing and status metadata.

The server thereby creates a traceable link structure that enables subsequent verification and audit operations without re-invoking the generative AI model.

Input: the final answer information, the inquiry record, and the list of context identifiers.

Output: a stored trace record that maps the inquiry, the final answer, and basis information identifiers.
Step 13:

The server prepares a response object that encapsulates the final answer information and optional auxiliary data, such as references to underlying documents or confidence indicators. The server serializes this response object into a format such as JSON and sets appropriate HTTP response headers, including a success status code.

The server sends the serialized response to the terminal via the communication network.

Input: the final answer information and associated metadata.

Output: a serialized response message containing the final answer information transmitted to the terminal.
Step 14:

The terminal receives the response message from the server through the networking stack and passes the message to the application.

The terminal deserializes the response, extracts the final answer information, and creates a message object suitable for rendering on the display.

The terminal may store the response in a local cache to allow quick redisplay if the user revisits the conversation history.

Input: the serialized response message received from the server.

Output: a display-ready message object that contains the final answer information.
Step 15:

The terminal updates the user interface to append the final answer information as a new message element in a chat or dialog view.

The terminal applies layout rules to wrap text, handle line breaks, and adjust font size according to display settings and user preferences.

The terminal scrolls the view, if necessary, to ensure that the newly added message is visible, and waits for further input actions from the user.

Input: the display-ready message object containing the final answer information.

Output: a rendered visual presentation of the final answer information on the terminal screen for the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional conversational information systems that rely on generative AI models tend to treat the model output as a final answer without robust technical control over consistency with authoritative knowledge sources such as operational rules or knowledge bases. As a result, such systems may generate responses that are factually incorrect, inconsistent with internal manuals, or unstable across similar queries. This degrades the reliability of the system and imposes additional manual review workloads on human operators.

Moreover, in typical architectures, the construction of a prompt sentence for a generative AI model is performed in an ad hoc, static manner, without systematic use of structured internal representations of user inquiries or historical generation behavior. Consequently, the system cannot effectively adapt the prompt sentence to the specific context, to a detected emotional state of the user, or to prior verification results, which limits both answer quality and robustness.

Additionally, many existing systems do not provide a closed technical loop that uses evaluation results and knowledge verification to automatically regenerate or correct answers. Instead, they depend on external post-editing or rule-based fallbacks, which increases latency and reduces the real-time nature of the interaction. This deficiency is particularly acute in environments where responses must strictly conform to organizational policies and knowledge materials, such as regulated industries or large-scale customer support centers. There is also a lack of mechanisms for systematically recording, in a machine-utilizable form, the relationships among generated answers, the knowledge information actually used, and the corresponding prompt sentences. Without such structured history information, it is difficult for the system to improve over time its generation conditions, such as prompt templates or parameter settings, which hinders continuous optimization of the underlying computer-implemented dialogue control.

Accordingly, there is a need for a computer-implemented technique that improves the operation of an information processing system by (i) converting natural-language inquiry data into structured internal representations, (ii) dynamically generating and adjusting prompt sentences for a generative AI model, (iii) automatically verifying and, when necessary, regenerating responses based on stored knowledge information, and (iv) storing and exploiting history information to update generation conditions. Such a technique should technically enhance the reliability, consistency, and efficiency of the server-side processing itself, rather than merely providing a new business rule or human workflow.

The specific processing by the specific processing unit 290 of the data processing device 12 in Application Example 1 is realized by the following means.

The present invention provides a server comprising a processor configured to receive inquiry data expressed in natural language from an information terminal, convert the inquiry data into a structured internal representation, generate a prompt sentence for a generative AI model on the basis of the inquiry data and the internal representation, transmit the prompt sentence to an external chatbot-generation information processing function, receive a response text generated on the basis of the prompt sentence, acquire knowledge information describing operational rules from an information storage mechanism, compare the response text with the knowledge information to evaluate consistency, when inconsistency is detected, newly generate a correction prompt sentence including the knowledge information and re-input the correction prompt sentence to the generative AI model to obtain a corrected response text, convert at least one of the response text and the corrected response text into display data for the information terminal, estimate an emotional state of the user and adjust at least one of the prompt sentence and the response text according to the emotional state, and store, as history information, a generation history including the response text, the corrected response text, the knowledge information, and the prompt sentence, and update generation conditions for subsequent prompt sentences on the basis of the history information. This enables technical improvement of the operation of the computer system by establishing an automated, knowledge-constrained feedback loop for generative AI responses, enhancing consistency and reliability of server-side answer generation, reducing manual intervention, and allowing the server to iteratively optimize prompt generation and response control based on accumulated machine-readable history information.

The term “system” refers to a combination of hardware and software components that cooperate to execute information processing, including at least one processor and associated memory and communication interfaces.

The term “processor” refers to a hardware information processing unit, such as a central processing unit or other programmable processing circuitry, configured to execute instructions stored in a memory to perform specified functions.

The term “communication network” refers to any wired or wireless data transmission infrastructure that enables exchange of information between an information terminal and a server, including but not limited to local area networks, wide area networks, and public packet-switched networks.

The term “information terminal” refers to an information processing apparatus operated by a user, such as a personal computer, a mobile communication device, or any other computing device capable of sending and receiving data over a communication network.

The term “user” refers to a human operator or an entity that issues an inquiry to the system through the information terminal and receives a response from the system.

The term “inquiry data” refers to electronic data representing a request, question, or instruction provided by the user, expressed in natural language, and transmitted from the information terminal to the server.

The term “natural language” refers to a human language, whether spoken or written, used for everyday communication, as opposed to a formal programming language or markup language.

The term “structured internal representation” refers to a data structure generated from inquiry data, in which elements of the natural-language inquiry are organized into machine-interpretable fields, attributes, or symbols suitable for subsequent processing.

The term “prompt sentence” refers to electronic text or structured data that specifies instructions, context, and input content for a generative AI model, and is used to control or condition the generation of a response by the model.

The term “generative AI model” refers to a machine learning model, such as a neural network, configured to generate output data including text based on input data including a prompt sentence, by performing statistical inference learned from training data.

The term “chatbot-generation information processing function” refers to a remote or local information processing service that provides an interface to a generative AI model and returns generated response data based on a received prompt sentence.

The term “request” refers to a data structure or message transmitted from the server to the chatbot-generation information processing function that includes at least a prompt sentence and, optionally, additional parameters for controlling generation of a response.

The term “response data” refers to a data structure or message returned from the chatbot-generation information processing function to the server, including at least a response text generated in accordance with a prompt sentence.

The term “response text” refers to electronic text representing an answer, explanation, or other output generated by the generative AI model in response to a prompt sentence. The term “information storage mechanism” refers to one or more storage devices and related software configured to store, retrieve, and manage data, including databases, file systems, or other data repositories.

The term “knowledge information” refers to data describing operational rules, policies, manuals, or other authoritative reference materials of an organization, stored in the information storage mechanism and used to verify or constrain generated responses.

The term “operational rules” refers to procedures, policies, conditions, or guidelines established by an organization for handling inquiries, performing transactions, or managing services, and recorded as part of the knowledge information.

The term “consistency” refers to a state in which a response text does not contradict and is in conformity with the relevant knowledge information, including important conditions, constraints, and factual details.

The term “evaluation” refers to a computational process performed by the processor to determine whether a response text is consistent with the knowledge information, based on comparison, analysis, or other algorithmic procedures.

The term “correction prompt sentence” refers to a prompt sentence generated by the processor that explicitly includes relevant knowledge information and is designed to cause the generative AI model to correct or regenerate a response text so as to conform to the knowledge information.

The term “corrected response text” refers to a response text generated by the generative AI model based on a correction prompt sentence and intended to resolve inconsistency with the knowledge information.

The term “display data” refers to data formatted by the processor so as to be directly presentable on an output interface of the information terminal, including text, layout information, and optional metadata.

The term “real time” refers to a processing characteristic in which the system generates and returns a response to the information terminal within a time period short enough that a user can interact with the system in a conversational manner without perceiving undue delay.

The term “emotional state” refers to an estimated affective condition of the user, such as satisfaction, dissatisfaction, anger, or confusion, inferred by the processor from inquiry data or interaction context.

The term “style of expression” refers to linguistic characteristics of a text, including politeness level, tone, formality, length, and degree of detail, which can be adjusted by the processor for at least one of a prompt sentence and a response text.

The term “history information” refers to stored records that associate, in a machine-readable form, elements including response texts, corrected response texts, knowledge information used, prompt sentences, and optionally timestamps or session identifiers.

The term “generation history” refers to a subset of the history information that describes how a given response text or corrected response text was generated, including the corresponding prompt sentence, model parameters, and knowledge information involved.

The term “generation conditions” refers to parameters, templates, or control settings used in creating prompt sentences or configuring the generative AI model, such as prompt structure, instruction content, and model operation parameters.

The term “update” refers to a process in which the processor modifies or replaces at least part of the generation conditions on the basis of history information to improve subsequent prompt generation or response control.

In an embodiment, a server cooperates with one or more terminals operated by users to implement the claimed system. The server includes at least one processor, a main memory, a non-volatile storage device, and a network interface. The server is connected to a communication network such as the Internet or a wide-area packet network. The terminal is realized by a general-purpose computing device, such as a smartphone, a tablet computer, or a desktop computer, including a processor, a memory, a display, an input interface, and a communication module. The user operates the terminal to transmit inquiry data expressed in natural language to the server and to receive display data including response text from the server.

The server executes an information processing program on an execution environment such as an operating system and an application runtime (for example, a server-side JavaScript runtime and a web application framework). The server uses a network communication library to receive data from the terminal and to transmit data to an external chatbot-generation information processing function that provides access to a generative AI model. The server uses a storage engine, such as a relational database system or a document store, to store knowledge information describing operational rules, history information, and configuration parameters.

The server converts inquiry data into a structured internal representation. The server uses natural-language processing components that execute on the processor. For example, the server tokenizes the inquiry text into word units, assigns part-of-speech tags, and segments the text into syntactic phrases. The server constructs a data structure, such as a hierarchical object or a record with fields including intent type, detected entities, semantic roles, and sentiment features. The server uses algorithms such as a sequence labeling model based on a bidirectional recurrent neural network or a transformer encoder to detect entities (e.g., product identifiers, time periods, policy terms) and to infer an intent label for the inquiry. These operations constitute specific data transformations from raw character sequences into symbolic and numerical features that are used by later components.

The server generates a prompt sentence for the generative AI model on the basis of the structured internal representation. The server constructs a textual instruction that explicitly encodes constraints and context extracted from the internal representation. The server assembles a prompt sentence by concatenating template segments and variable segments. An example of a prompt sentence generated by the server is:
“You are a support assistant that must answer only according to the official organizational policies. User question: ‘Is it possible to return this product?’ Based on the stored return policy, generate a concise and accurate answer. If there are conditions such as time limits or product state, clearly describe them.”

In another example, when the server detects a specific policy domain from the internal representation, the server generates a domain-specific prompt sentence such as:
“You are a policy-compliant assistant. Answer the following question strictly according to the internal return policy. User question: ‘How long do I have to request a refund?’ If the policy sets a maximum period, state the number of days and any conditions.”

The server thereby performs non-trivial algorithmic composition of the prompt sentence from structured features, rather than simply relaying the raw user text, which improves control over the behavior of the generative AI model.

The server uses an external chatbot-generation information processing function that exposes the generative AI model through a programmatic interface. The generative AI model is realized by a neural-network-based language model, for example a transformer architecture comprising an embedding layer, multiple self-attention layers, feed-forward layers, and a final output projection layer. The model receives tokenized representations of the prompt sentence and produces a probability distribution over possible next tokens at each generation step. The server configures generation parameters such as temperature, maximum token length, and top-k or nucleus sampling thresholds, which influence the entropy and determinism of the generated response text.

The server internally manages the tokenization and detokenization processes. The server converts the prompt sentence into a sequence of token identifiers according to a subword tokenization scheme, such as byte-pair encoding or unigram language modeling. The server passes the token sequence and configuration parameters to the chatbot-generation information processing function via the network interface. The external function executes the generative AI model on specialized hardware, such as graphic processing units or tensor processing units, and performs numerical computations including matrix multiplications, normalization, and activation functions to generate output token probabilities.

The server receives the generated response text from the external function. The server parses the response data, reconstructs the response text from token identifiers, and stores the response text in association with the corresponding inquiry data, prompt sentence, and model parameters as history information. The server thereby maintains a data structure in the storage device that records, for each interaction, a generation history including at least: a conversation identifier, the inquiry text, the internal representation, the prompt sentence, model configuration values, the first generated response text, any corrected response text, and identifiers of knowledge information used for verification.

The server acquires knowledge information from an information storage mechanism. The server maintains one or more databases that store operational rules, such as return policies, eligibility criteria, and exception rules, in a structured or semi-structured format. For example, the server stores a return policy as records with fields including maximum number of days, condition requirements, excluded product categories, and descriptive text. The server uses search algorithms such as keyword-based retrieval, index-based retrieval, or vector-based similarity retrieval to obtain knowledge records that are relevant to the structured internal representation of the inquiry.

The server compares the response text with the acquired knowledge information to evaluate consistency. The server decomposes the response text into propositional segments, for example by using dependency parsing and semantic role labeling. The server extracts key attributes from the response text, such as numeric values (e.g., “30 days”), logical conditions (e.g., “unused,” “original packaging”), and modality expressions (e.g., “can,” “not allowed”).

The server maps these extracted attributes to corresponding fields in the knowledge information. The server then executes a rule-based evaluation algorithm that applies non-conventional comparison rules, such as:
(1) If the response mentions a time limit, the value must be equal to or more restrictive than the maximum days field in the knowledge information.
(2) If the knowledge information requires specific item conditions, the response must not omit all such conditions.
(3) If the knowledge information includes explicit exceptions, the response must not contradict those exceptions.

The server computes a consistency score based on the number of satisfied rules and the presence of contradictions. The server decides that the response text is inconsistent when the score falls below a threshold or when specific contradiction patterns are detected. This evaluation is implemented as a deterministic algorithm on structured data, not as a purely subjective human review, and it directly controls subsequent machine operations. When an inconsistency is detected, the server generates a correction prompt sentence that includes the relevant knowledge information. For example, the server may create a correction prompt sentence such as:
“Here is the official return policy: ‘Returns are accepted within 14 days of purchase only for unused items in their original packaging.’ The previous answer incorrectly stated a period of 30 days. Generate a corrected answer that exactly follows the official return policy. Answer in clear and concise language.”

The server supplies the correction prompt sentence to the generative AI model through the same chatbot-generation information processing function and obtains a corrected response text. The server again evaluates the corrected response text against the knowledge information using the rule-based algorithm. By performing this iterative process under automatic control, the server establishes a feedback loop that constrains the generative AI model to produce responses that are aligned with the stored knowledge information, while maintaining real-time performance.

The server estimates an emotional state of the user and adjusts at least one of the prompt sentence and the response text according to the estimated emotional state. The server uses a sentiment analysis model implemented by a separate classifier network or by extracting features from the internal representation. For example, the server processes the inquiry data using a transformer-based classifier trained on labeled emotional data. The classifier outputs probabilities for emotional labels such as “neutral,” “frustrated,” and “confused.” The server applies thresholding to select the most likely emotional state. The server then modifies parameters for the prompt sentence template, such as selecting more polite expressions, adding reassurance phrases, or controlling the level of detail in the answer. This adjustment is applied in a systematic manner using predefined mapping rules between emotional states and linguistic style parameters, thereby enabling consistent and algorithmic control of expression style.

The server converts at least one of the response text and the corrected response text into display data for the terminal. The server formats the text with layout information and metadata so that the terminal can render it on a display. The server may supplement the response with identifiers or links to the underlying knowledge information, allowing the terminal to present expandable sections that show the source policy text. The server optimizes the size of display data to reduce communication overhead, for example by compressing redundant information or omitting unnecessary metadata, which contributes to reduced network latency and improved responsiveness for the user.

The server uses the history information to update generation conditions of subsequent prompt sentences. The server periodically or incrementally analyzes stored history records to detect patterns, such as frequent inconsistencies or repeated corrections for specific types of inquiries. The server adjusts prompt generation parameters accordingly, for instance by:
(1) Modifying the base instructions in the prompt sentence to more strongly emphasize adherence to certain policy fields.
(2) Changing generation parameters such as temperature to reduce variability for high-risk domains.
(3) Introducing additional contextual phrases that make the internal representation more explicit to the generative AI model.

These updates are computed by algorithms operating on the history database, such as statistical aggregation, clustering of error cases, or reinforcement-learning-style updates of prompt templates based on reward signals derived from consistency scores. By performing these updates automatically in the server, the system improves the precision and stability of subsequent responses without manual rule tuning.

The terminal receives display data from the server through the communication network. The terminal parses the display data, extracts the response text, and presents the content on the display device. The terminal also records minimal session information locally, such as conversation identifiers, for purposes of reconnection or resynchronization. The terminal may transmit user interaction signals, such as explicit feedback or follow-up inquiries, back to the server, which then become part of the history information.

The user interacts with the system by inputting natural-language inquiries and viewing generated responses. The user may ask domain-specific questions, such as questions about return policies, usage conditions, or eligibility criteria. The user observes that the responses are consistent with official rules and that the system responds in real time with appropriate style adjustments based on the user's state. The user does not need to manage prompt sentences or knowledge information directly; these aspects are handled autonomously by the server.

The described configuration leads to specific technical effects that go beyond mere automation of human decision making. The server reduces processing latency by using structured internal representations and predefined comparison rules, so that the consistency evaluation can be executed in linear or near-linear time with respect to the length of the response text and the size of the relevant knowledge records, rather than performing complex ad hoc text searches on entire knowledge bases. The server improves accuracy by algorithmically enforcing policy constraints on the generated responses and by iteratively correcting inconsistent outputs using correction prompt sentences that embed authoritative knowledge. The server improves data management by maintaining structured history information that associates each response with the precise knowledge information and prompt sentence used, enabling systematic analysis and automated refinement of generation conditions.

In one variation, the server integrates an embedding module that computes vector representations of both inquiry data and knowledge information using the same transformer encoder as used in the generative AI model. The server stores these vectors in a vector index structure, such as an approximate nearest-neighbor index. When the server acquires relevant knowledge information, the server searches the vector index rather than relying only on keyword matching. This configuration improves retrieval accuracy and speed, which reduces the number of inconsistent responses and therefore reduces the need for repeated corrections, further improving responsiveness.

In another variation, the server deploys multiple generative AI models with different sizes or specialization levels. The server selects a model based on complexity and risk level inferred from the structured internal representation. For simple, low-risk inquiries, the server may select a smaller model to reduce computational cost and response time. For complex, policy-critical inquiries, the server may select a larger, more accurate model. The server thus implements a dynamic model-selection algorithm, which constitutes a technical optimization that balances computational resource usage and answer quality.

In yet another variation, the server includes a module that performs offline training or fine-tuning of a smaller generative model using history information. The server constructs training examples from pairs of prompt sentences and corrected response texts and updates the parameters of the smaller model using gradient-based optimization with a cross-entropy loss function. The server thereby creates a specialized model that approximates the behavior of the external large generative AI model under the organization's policy constraints. During operation, the server can first query the specialized model and only fall back to the external model when the specialized model's confidence is low, as measured by entropy or margin criteria. This approach reduces communication load and latency and further grounds the technical contribution in improved computer performance.

Through these embodiments and variations, the server, the terminal, and the user cooperate within a concrete technical architecture. The server performs specific data transformations, structured comparisons, and feedback-controlled generation of prompt sentences for a generative AI model, resulting in improved processing speed, higher consistency with knowledge information, reduced error rate, and more efficient use of computational and communication resources.

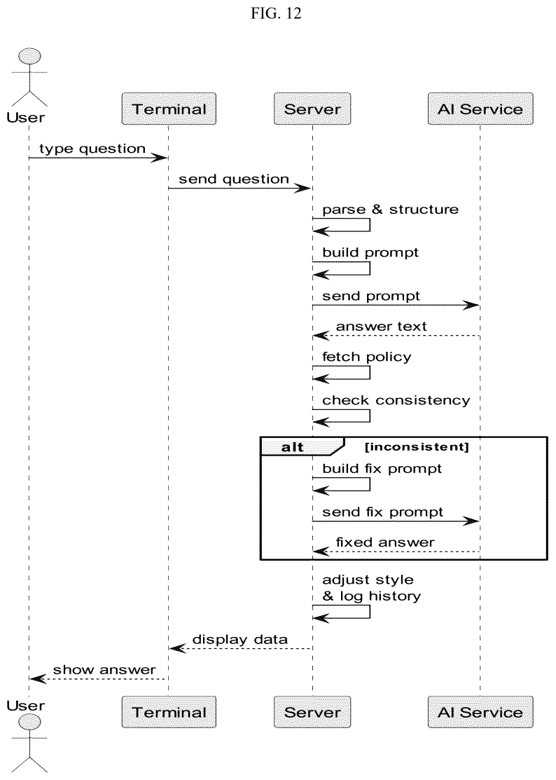

The following describes the processing flow using FIG. 12.
Step 1:

The user operates the terminal to input inquiry data expressed in natural language.

The terminal displays an input interface, receives a text string such as “Is it possible to return this product?” from the user via a keyboard or touch input, and creates an inquiry object that includes at least the text string, a user identifier, and a session identifier.

Input: raw keystroke or touch events from the user.

Processing: the terminal aggregates the events into a UTF-8 text string, attaches metadata (user ID, session ID, timestamp), and serializes the data into a structured format.

Output: structured inquiry data containing the natural-language text and associated metadata.
Step 2:

The terminal transmits the structured inquiry data to the server via a communication network.

The terminal constructs a network request message that includes the inquiry data in the body, sets protocol headers (such as content type and authentication token), and sends the message to a predefined endpoint of the server.

Input: structured inquiry data created in Step 1.

Processing: the terminal converts the data into a network payload (for example, a text-encoded representation), opens a network connection using a transport protocol, and writes the payload onto the connection.

Output: a network packet stream carrying the inquiry data to the server.
Step 3:

The server receives the network packet stream and reconstructs the structured inquiry data. The server listens on a network port, assembles incoming packets, parses protocol headers, and decodes the payload into an internal data structure that represents the inquiry text and metadata.

Input: network packet stream from the terminal.

Processing: the server performs protocol handling, error checking, and decoding of the payload into an in-memory object with fields for text, user ID, session ID, and timestamp.

Output: an internal inquiry data object stored in main memory.
Step 4:

The server converts the inquiry text into a structured internal representation.

The server applies tokenization, part-of-speech tagging, and syntactic and semantic analysis to the inquiry text, and creates a data structure containing detected intent, entities, and sentiment features.

Input: inquiry data object containing the natural-language text.

Processing: the server executes natural-language processing algorithms, including segmentation of the text into tokens, mapping tokens to tags, and applying a model such as a transformer encoder to produce numerical feature vectors, which are then mapped to discrete labels (intent category, entity types, emotional polarity).

Output: a structured internal representation object that encodes interpreted meaning and attributes of the inquiry.
Step 5:

The server generates a prompt sentence for a generative AI model based on the structured internal representation and the original inquiry text.

The server selects a prompt template according to the detected intent and domain, substitutes variables such as the inquiry text and domain name into the template, and concatenates instruction segments to form a single prompt sentence.

Input: structured internal representation and inquiry text.

Processing: the server performs rule-based template selection, string concatenation, insertion of control phrases (for example, restrictions to official policies), and normalization of whitespace and punctuation to construct a coherent instruction.

Output: a prompt sentence such as “You are a support assistant that must answer only according to the official organizational policies. User question: ‘Is it possible to return this product?’ Based on the stored return policy, generate a concise and accurate answer. If there are conditions such as time limits or product state, clearly describe them.”
Step 6:

The server prepares model input data for the external chatbot-generation information processing function.

The server converts the prompt sentence into a sequence of token identifiers using a subword tokenization scheme and attaches generation parameters, such as temperature and maximum output length, in a model-specific request structure.

Input: prompt sentence generated in Step 5.

Processing: the server applies a tokenization algorithm to split the prompt string into subword units and map each unit to an integer token ID, and then collects the IDs and parameters into a request object that conforms to the interface specification of the generative AI model. Output: a model request object containing tokenized prompt data and generation parameters.
Step 7:

The server transmits the model request object to the external chatbot-generation information processing function and initiates response generation.

The server encodes the model request object as a network payload, sends it through the network interface to the external function, and waits for the generative AI model to compute output.

Input: model request object created in Step 6.

Processing: the server serializes the object, opens a secure network session, sends the serialized data, and manages asynchronous waiting or streaming reception according to the protocol.

Output: a network exchange that triggers execution of the generative AI model and results in response data being sent back to the server.
Step 8:

The server receives and reconstructs the response text produced by the generative AI model.

The server collects incoming response packets from the external function, decodes the payload, and converts the returned token identifiers or text segments into a complete response text string.

Input: network response payload from the external chatbot-generation information processing function.

Processing: the server parses the response format, aggregates partial segments if streaming is used, maps token IDs back to character sequences using a detokenization algorithm, and concatenates the sequences into a final text.

Output: a raw response text generated by the generative AI model.
Step 9:

The server acquires relevant knowledge information from an information storage mechanism based on the structured internal representation.

The server uses fields such as intent, detected entities, and domain type to construct a retrieval query and executes the query against a database or index that stores operational rules and policies.

Input: structured internal representation and, optionally, the original inquiry text.

Processing: the server generates search keys (keywords, identifiers, or embedding vectors), performs a lookup or similarity search on stored knowledge records, filters the retrieved records by domain and validity period, and extracts the most relevant portions.

Output: one or more knowledge information objects that describe rules applicable to the inquiry.
Step 10:

The server evaluates consistency between the response text and the knowledge information.

The server analyzes the response text to extract key conditions and values, maps them to corresponding fields in the knowledge information, and computes a consistency score or decision.

Input: response text from Step 8 and knowledge information from Step 9.

Processing: the server decomposes the response text into clauses, identifies numeric values and condition phrases, and uses comparison rules to check whether each extracted element matches or is compatible with the corresponding policy fields; the server aggregates the results to determine whether contradictions or omissions are present. Output: a consistency evaluation result indicating “consistent” or “inconsistent” and, optionally, a list of mismatched items.
Step 11:

The server generates a correction prompt sentence when the consistency evaluation indicates inconsistency.

The server constructs a new instruction that embeds the authoritative knowledge information, explains the detected discrepancy, and requests a corrected answer that follows the rules exactly.

Input: consistency evaluation result, original response text, and knowledge information.

Processing: the server selects a correction template, inserts the relevant policy text, specifies what was incorrect (such as an incorrect number of days), and builds a correction prompt sentence such as “Here is the official return policy: ‘Returns are accepted within 14 days of purchase only for unused items in their original packaging.’ The previous answer incorrectly stated a period of 30 days. Generate a corrected answer that exactly follows the official return policy. Answer in clear and concise language.”

Output: a correction prompt sentence that constrains a new generation by the generative AI model.
Step 12:

The server performs a secondary generation to obtain a corrected response text using the correction prompt sentence.

The server tokenizes the correction prompt sentence, creates a new model request object, sends it to the external chatbot-generation information processing function, and reconstructs the returned text as in previous steps.

Input: correction prompt sentence generated in Step 11.

Processing: the server repeats tokenization, request formation, network transmission, response reception, and detokenization, thereby executing an additional generation step conditioned on the embedded knowledge.

Output: a corrected response text that is expected to be consistent with the knowledge information.
Step 13:

The server selects a final response text to be presented to the user.

The server chooses between the original response text and the corrected response text based on the consistency evaluation result and, if needed, a second evaluation of the corrected text, and marks the chosen text as final.

Input: original response text, corrected response text, and consistency evaluation results.

Processing: the server applies selection rules (for example, always preferring the corrected text when available and consistent), updates the interaction record with the selected text, and sets flags indicating the consistency status.

Output: a final response text ready for formatting and delivery to the terminal.
Step 14:

The server adjusts the style of the final response text according to an estimated emotional state of the user.

The server uses sentiment features in the structured internal representation to classify the user's emotional state and modifies the linguistic style of the final response text by adding or replacing phrases without altering the policy content.

Input: final response text from Step 13 and emotional state information derived from the inquiry data.

Processing: the server selects a style profile (e.g., more polite, more reassuring), applies text-level transformations such as inserting apology phrases or softening directives, and ensures that the adjustments do not remove mandatory conditions from the text. Output: a style-adjusted final response text.
Step 15:

The server converts the style-adjusted final response text into display data for the terminal and records history information.

The server wraps the text in a response structure that includes layout hints, identifiers of the knowledge information used, timestamps, and any diagnostic metadata, and stores an entry associating the inquiry, internal representation, prompt sentences, and response texts.

Input: style-adjusted final response text and associated metadata (knowledge identifiers, prompt sentences, evaluation results).

Processing: the server creates a display data object with fields for text content and optional reference links, serializes it for transmission, and inserts a history record into persistent storage for later analysis and adaptive updates.

Output: display data suitable for rendering by the terminal and a stored history record.
Step 16:

The server transmits the display data to the terminal via the communication network.

The server sends the serialized display data as a response message to the terminal, managing protocol headers and connection control to ensure reliable delivery.

Input: display data generated in Step 15.

Processing: the server writes the data into the network stream, handles possible retransmissions or acknowledgments, and closes or maintains the connection according to the session policy.

Output: a network packet stream containing the display data destined for the terminal.
Step 17:

The terminal receives the display data, reconstructs the response text, and presents it to the user.

The terminal decodes the incoming payload, extracts the final response text and any associated references, and renders the content on the display in a conversational or message format.

Input: network packet stream from the server containing the display data.

Processing: the terminal performs protocol parsing, deserialization of the display data object, mapping of text and metadata to user interface elements, and graphical rendering on the screen.

Output: a visible representation of the final response text shown to the user, enabling the user to read the answer and optionally initiate a new inquiry.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented inquiry support systems suffer from several technical limitations in how they process natural language inquiries and access backend data resources. In many existing systems, the mapping from an unstructured natural language inquiry to structured search criteria for backend data stores is implemented as a fixed set of manually designed rules or templates. As the variety and complexity of inquiries increase, the rule sets must be expanded and maintained, which leads to brittle behavior, high error rates when unanticipated wording is used, and increased consumption of computing and development resources. In particular, when the inquiry text deviates from expected patterns, the system may fail to extract the correct intent, may generate inefficient or incorrect database queries, and may require human intervention, thereby degrading throughput and latency of the overall computing system.

Furthermore, known systems often separate natural language understanding from data access in a rigid pipeline that lacks adaptive feedback. The natural language component may output coarse-grained classifications, while the data access component independently constructs generic queries. This separation can cause redundant data retrieval, unnecessary load on storage subsystems, and increased response times because the query is not tightly tailored to the actual intent inferred from the natural language input. As a result, the utilization efficiency of processor cycles, memory bandwidth, and storage access in the server is reduced.

In addition, many systems provide static responses that do not adapt to user-specific emotional context or quality constraints. Without explicit, machine-executable representation of user intent and required data fields, the server cannot consistently generate optimized queries, nor can it systematically verify that generated answers conform to prescribed rule information, such as business rules or knowledge resources. This leads to inconsistent answer quality, increased need for post-processing or manual review, and difficulty in scaling the system while maintaining reliability.

Accordingly, there is a need for an improved computer-implemented technique that uses a generative AI model in conjunction with explicit prompt sentences to dynamically convert unstructured natural language inquiries into machine-usable intent information, request information, and query expressions. There is also a need for a server-side architecture that integrates generative analysis, structured query generation, targeted data retrieval, and answer verification into a unified processing flow. Such an architecture should improve the efficiency and reliability of inquiry processing by reducing manual rule maintenance, optimizing access to stored business information, and enabling automated adaptation of answer content in response to inferred emotion information and rule-conformance checks. The technical problem is to improve the way a processor in a server transforms incoming natural language inquiry information into structured processing steps, data access operations, and answer generation so as to enhance accuracy, processing speed, and resource utilization of the computing system as a whole.

The specific processing by the specific processing unit 290 of the data processing device 12 in Example 2 is realized by the following means.

The present invention provides a server comprising a processor configured to receive inquiry information from a user apparatus via a communication scheme, analyze the inquiry information by using a natural language processing technique to extract intent information and request information, generate a prompt sentence as inquiry-processing generation information based on the intent information and the request information, input the prompt sentence to a generative information processing apparatus to obtain analysis result information or answer candidate information, generate a query expression for searching business information stored in a storage apparatus in accordance with inquiry conditions based on the analysis result information, obtain target information from an information management apparatus by using the query expression, generate answer information as processing result information for the inquiry on the basis of the target information and the analysis result information, generate notification information for providing the answer information to the user apparatus, and automatically transmit the answer information by using the notification information via a message distribution apparatus or a communication path to cause the user apparatus to present the answer information, and further configured, in some embodiments, to estimate emotion information on the basis of the analysis result information to adjust an expression style or content of the answer information, and to determine, by using a verification prompt sentence to the generative information processing apparatus or a rule determination process, whether the answer information conforms to prescribed information including business rule information or knowledge information, and to correct or regenerate the answer information based on a determination result. This enables the server to transform unstructured natural language inquiries into structured, intent-aware query expressions and verified answer information in an automated manner, thereby improving the efficiency of processor-controlled inquiry processing, reducing unnecessary access to storage resources, enhancing response accuracy and consistency, and providing adaptive answer generation that is robust to diverse inquiry formulations and user contexts.

The term “processor” refers to a hardware or virtual computation unit, such as a central processing unit, a microprocessor, a processing core, or an execution environment, that executes machine-readable instructions to perform the functions described in the present specification.

The term “user apparatus” refers to an information processing device operated by a user, such as a terminal, a client device, a communication device, or a computing device, that transmits inquiry information to a server and receives answer information from the server.

The term “communication scheme” refers to a communication mechanism, protocol, or interface, including wired or wireless communication, that enables transmission and reception of data between the user apparatus and the server.

The term “inquiry information” refers to information representing a request, question, or demand from a user, including natural language text, structured data, or other input data, that is processed by the server to obtain an answer.

The term “natural language processing technique” refers to a computer-implemented technique for processing, analyzing, or interpreting natural language expressions, including tokenization, syntactic analysis, semantic analysis, intent detection, entity extraction, or other language understanding operations.

The term “intent information” refers to information representing a meaning, objective, or purpose inferred from the inquiry information, including a type of requested operation, a category of inquiry, or a target process to be executed by the server.

The term “request information” refers to information representing specific parameters, conditions, or data requirements included in or inferred from the inquiry information, such as a target item, a time condition, a quantity, or a location.

The term “prompt sentence” refers to a text string or sequence of tokens supplied to a generative information processing apparatus, the text string including an instruction, context, or example that guides generation or analysis by the generative information processing apparatus.

The term “inquiry-processing generation information” refers to information used to cause a generative information processing apparatus to perform analysis or generation related to an inquiry, including a prompt sentence that encodes the intent information and request information derived from the inquiry information.

The term “generative information processing apparatus” refers to a hardware and software system, including a generative AI model, that generates or analyzes information in response to an input such as a prompt sentence, and that outputs analysis result information, answer candidate information, or other generated data.

The term “analysis result information” refers to information output from the generative information processing apparatus in response to a prompt sentence, the information including structured or semi-structured data representing interpreted intent, extracted parameters, or other intermediate results used for subsequent processing.

The term “answer candidate information” refers to information output from the generative information processing apparatus that represents a tentative or draft answer to the inquiry information, which may be used directly or refined by the server.

The term “storage apparatus” refers to a data storage resource, such as a memory device, a database system, a file system, or a storage subsystem, that stores business information or other data used for processing inquiries.

The term “business information” refers to information related to operations, transactions, inventory, orders, rules, or other business-related data that is stored in the storage apparatus and retrieved in response to inquiry information.

The term “query expression” refers to a structured expression for accessing data in the storage apparatus or in an information management apparatus, including a database query, a search request, or another machine-readable retrieval instruction.

The term “inquiry conditions” refers to conditions or constraints derived from the analysis result information or the inquiry information, including filters, ranges, identifiers, or other parameters used to generate the query expression.

The term “information management apparatus” refers to a system or component that manages access to data resources, such as a database server, an application server, or a data management system, and that executes the query expression to return target information.

The term “target information” refers to information retrieved from the storage apparatus or the information management apparatus in accordance with the query expression, and used to generate answer information for the inquiry.

The term “processing result information” refers to information generated by the processor as a result of processing the inquiry information, including answer information that reflects both the analysis result information and the target information.

The term “answer information” refers to information representing a response to the inquiry information, including explanatory text, numerical data, or other content derived from the analysis result information and the target information.

The term “notification information” refers to information used to control transmission or presentation of answer information, including message headers, addressing information, formatting instructions, or metadata for delivering the answer information to the user apparatus.

The term “message distribution apparatus” refers to a system or service that distributes messages, such as an electronic mail service, a message queue system, or a push notification service, used to transmit answer information based on the notification information.

The term “communication path” refers to a logical or physical channel through which data is transmitted between devices or systems, including network connections, communication lines, or virtual communication channels.

The term “emotion information” refers to information representing an estimated emotional state, attitude, or tone of the user inferred from the inquiry information or the analysis result information, such as satisfaction, urgency, frustration, or politeness.

The term “expression style” refers to a manner of presenting answer information, including wording, tone, level of detail, politeness, or formatting of the answer information, which may be adjusted based on the emotion information.

The term “prescribed information” refers to information defining constraints, rules, or reference knowledge that answer information should conform to, including business rule information, knowledge information, manuals, or policy data.

The term “business rule information” refers to information that defines operational rules, constraints, or policies for a business process, such as allowable actions, conditions, thresholds, or processing procedures.

The term “knowledge information” refers to information representing accumulated knowledge, reference materials, manuals, or documentation that describes correct behavior, recommended answers, or standard procedures.

The term “verification prompt sentence” refers to a prompt sentence specifically designed to cause the generative information processing apparatus to verify or evaluate whether answer information conforms to prescribed information, and to output a determination result or correction suggestion.

The term “rule determination process” refers to a process executed by the processor to determine conformance of answer information to prescribed information, including rule-based evaluation, constraint checking, or comparison with stored business rule information or knowledge information.

The term “determination result” refers to information indicating an outcome of verification or rule determination, such as whether answer information is conforming or non-conforming, and may include reasons, flags, or required corrections.

The term “correct or regenerate” refers to operations in which the processor modifies existing answer information to resolve non-conformance, or generates new answer information, for example by adjusting content directly or by issuing another prompt sentence to the generative information processing apparatus.

In one or more embodiments, the server, the terminal, and the user cooperate to implement an inquiry processing system that uses a generative AI model and explicitly constructed prompt sentences to convert natural language inquiries into structured queries and verified answers.

The server includes a processor, a main memory, a non-volatile storage device, a network interface, and, in some embodiments, a dedicated hardware accelerator. The processor executes an operating system such as a general-purpose server operating system, and application software including a web server component, an application logic component, a database access component, and an AI interface component. The terminal includes a processor, a memory, a display, an input device, and a communication interface. The user operates the terminal to input inquiries and to view answers.

The server uses web server software such as representative HTTP server software to receive HTTP or HTTPS requests from the terminal. The server uses application frameworks, such as a typical server-side scripting framework or a general-purpose application framework, to implement application logic. The server uses database management software such as a relational database system (for example, one of plural commercially available relational database engines) to store and retrieve business information. The server uses a mail or message sending service such as a general-purpose message distribution service to send notifications to the terminal or to an address associated with the terminal.

The server uses a generative AI model that implements a transformer-based neural network architecture. The generative AI model includes a plurality of layers of self-attention blocks, feed-forward blocks, normalization operations, and positional encoding mechanisms. The server accesses the generative AI model via an API endpoint using a secure network protocol. In one embodiment, the generative AI model is pre-trained on a large corpus of natural language data and further fine-tuned on domain-specific inquiry logs and business documents. The server specifies model parameters such as temperature, maximum token length, and top-k or top-p sampling hyperparameters when the server sends a prompt sentence to the generative AI model.

The server represents inquiry information, intermediate analysis results, and business information by using specific data structures. The server stores each inquiry as a record including fields such as a user identifier, a terminal identifier, an inquiry text string, a timestamp, and contextual attributes. The server stores business information in relational tables having columns such as entity identifiers, attribute values, and temporal fields. For example, the server stores inventory information in a table having fields for item identifier, location identifier, date, and quantity. The server stores analysis result information from the generative AI model as structured records including fields for intent category, parameter list, time constraint, and required data fields.

The server uses a natural language processing technique to pre-process inquiry information before the server constructs a prompt sentence. The server performs tokenization, language detection, and, in some embodiments, character normalization and stop-word handling. The server extracts candidate entities or keywords by using a statistical model or a dictionary-based method. This pre-processing reduces the input length to the generative AI model and improves the accuracy of downstream mapping to structured parameters. By compressing the inquiry text into informative tokens, the server reduces bandwidth usage between the server and the generative AI model and reduces computation at the generative AI model. The server constructs a prompt sentence that encodes both an instruction and the inquiry content in a structured but flexible manner. The server uses a template that describes an expected JSON-like schema or structured format in natural language, while the server provides explicit field names and constraints. For example, the server uses a prompt sentence such as:
“You are an assistant that analyzes store inquiries.”

Analyze the intent of the following inquiry and extract the required data fields for a database query.

Output the result in the following format:
intent: [short description]
products: [comma-separated list]
date: [specific date expression or ‘none’]
needed_fields: [comma-separated list of field names]
Inquiry: “Please tell me today's stock status of Product A and Product B at store 001.”

The server uses a further prompt sentence to check answer conformance. For example, the server uses:
“You are a verification assistant.”

Given the following answer and the following business rules, determine whether the answer conforms to the rules.

If the answer does not conform, briefly explain the problem and suggest a corrected answer.
Answer: [answer text]
Business rules: “[summary of rules].”

The server uses a further prompt sentence to derive emotion information and expected tone.

For example, the server uses:
“Analyze the emotional tone of the following customer inquiry.”
Classify the emotion as one of: neutral, urgent, frustrated, satisfied.

Also output a brief guideline for response tone.
Inquiry: “[inquiry text].”

The server, by constructing such prompt sentences, causes the generative AI model to output not only a natural language response but also machine-usable intermediate data structures. This structured output enables the server to generate database queries and verification operations programmatically, which materially improves processor-controlled processing compared with manual rule authoring.

The server does not rely solely on the generative AI model to produce final answers. Instead, the server uses the generative AI model to transform unstructured text into explicit intent information and query parameters. The server then uses deterministic algorithms to map this information to query expressions suitable for relational database engines. For example, the server maps identified product names to product identifiers by using a lookup table, resolves a relative date term such as “today” to an absolute date by using a clock of the server, and constructs a parameterized SQL statement that uses indexes on item identifier and date fields. This mapping reduces full-table scans, improves cache locality at the database engine, and lowers I/O latency.

The server improves computation efficiency and communication load by decomposing inquiry processing into multiple independent modules. The server uses a module for pre-processing and filtering user inputs, a module for constructing prompt sentences, a module for interfacing with the generative AI model, a module for mapping analysis results to query expressions, a module for executing queries and aggregating results, and a module for generating and verifying answer information. Each module uses data structures optimized for its purpose. For example, the server uses a compact, fixed-size representation for intent categories, uses arrays for lists of parameters, and uses normalized tables with primary keys and foreign keys for business information. By separating these modules, the server can be scaled horizontally, and can cache intermediate results to reduce repeated computations. The server uses a generative AI model trained by supervised learning and possibly reinforcement learning to ensure that the model output is aligned with system objectives. During training, the server or a training subsystem minimizes a loss function that penalizes incorrect intent classification, incorrect parameter extraction, and non-conforming answer generation. The loss function includes a cross-entropy term for token prediction and additional terms for misclassification of intent or parameters. The training process updates weights of the neural network by backpropagation and gradient-based optimization algorithms such as stochastic gradient descent or adaptive moment estimation. The generative AI model uses multi-head attention mechanisms within each transformer block to compute context-aware representations of tokens in the prompt sentence. Each attention head computes attention scores, normalizes them by a softmax function, and aggregates value vectors. The model uses learned positional embeddings to encode order of tokens. The server improves technical performance by using the structured output of the generative AI model to avoid ambiguous interpretations and to prevent the generation of non-optimized queries. Because the generative AI model outputs explicit fields such as “intent,” “products,” “date,” and “needed_fields,” the server can verify and normalize each field. The server detects missing or inconsistent values and invokes fallback logic or additional prompt sentences to repair the intermediate result. For example, the server sends an additional prompt sentence:
“The following analysis result is missing a date.”

Assume that the user intends ‘today’ if no date is specified.

Given the inquiry below, output the same fields as before, but fill in the date accordingly.
Inquiry: “Please tell me the stock status of Product A.”

In this way, the server uses the generative AI model in a non-conventional control loop that progressively refines structured parameters, rather than using the generative AI model only as a one-shot text generator. This control loop reduces errors and retries at the database layer, thereby improving end-to-end latency.

The server further uses the generative AI model to verify that answer information conforms to business rule information and knowledge information. After the server obtains target information from the database engine and composes a preliminary answer text, the server constructs a verification prompt sentence that encapsulates the preliminary answer and a summary of relevant rules. By sending this verification prompt sentence to the generative AI model, the server obtains an indication of conformance and, if non-conformance exists, a suggested correction. The server selectively incorporates the suggested correction or applies deterministic rule-based adjustments. This dual-stage generation and verification reduces the likelihood of logically inconsistent or policy-violating answers without requiring manual review.

The server improves computational performance and reduces communication load by using compression and caching techniques. The server shortens prompt sentences by referencing predefined templates and identifiers instead of full rule texts, and the server uses parameterized markers that the generative AI model has learned during fine-tuning. The server caches commonly used prompt segments and instructs the generative AI model using shorter inputs, which decreases token count and API latency. The server also caches the mapping from frequent inquiry patterns to structured intent information, so that repeated inquiries can bypass a part of the generative AI model processing. These mechanisms reduce network bandwidth consumption to the AI service and reduce compute time inside the AI infrastructure.

The terminal provides a user interface that guides the user in forming inquiries but does not restrict the inquiry to pre-defined buttons or menus. The terminal displays a text input field, suggestions, and prior inquiry history. The user inputs a natural language question, such as “Please tell me today's stock status of Product A and Product B.” The terminal, in some embodiments, performs basic validation and may locally detect obvious formatting issues. The terminal then transmits the inquiry to the server via an HTTP POST request. The terminal receives answer information and displays it in a structured format, such as a table of items with quantities, as well as a natural language explanation. The terminal may highlight parts of the answer that correspond to specific parameters or intents, thereby improving readability and enabling users to verify that the system has correctly understood their request. The terminal in some embodiments provides feedback controls that allow the user to indicate whether the answer was useful or not. The server receives this feedback and stores it as training data for future retraining or fine-tuning of the generative AI model. The server aggregates such feedback data and uses it to adjust weights of the prediction components that generate intent and parameter extraction outputs. The server, or a training subsystem associated with the server, uses the feedback to modify training sets and adjust regularization parameters in the training process, thereby gradually improving model accuracy. The user mainly interacts with the terminal and does not need to know internal operations of the server or the generative AI model. However, the user indirectly benefits from the improved computer processing because the system returns answers more quickly and with fewer errors than systems that rely solely on fixed rule-based parsing. By offloading natural language understanding and structured parameter generation to the generative AI model under control of specific prompt sentences, the server significantly reduces the number of branch-heavy conditional statements that would otherwise be executed by a conventional parser. This reduces instruction cache misses and improves pipeline efficiency in the processor.

The server uses non-conventional processing sequences that differ from simple human task automation. A conventional human operator might read an email inquiry, interpret its meaning, search for information in a system, and type a reply. In contrast, the server decomposes the task into multiple machine-level steps that involve transforming text into parameter vectors, mapping parameters into query expressions, executing queries against indexed tables, and performing verification using learned representations. The server does not simply mimic human reasoning; the server uses internal vector representations and attention mechanisms that have no direct human analog, and uses optimization-based learning to minimize a quantitative loss function.

The server can be implemented in various embodiments. In one embodiment, the generative AI model is hosted by a remote AI service, and the server accesses the AI service via an external network. In another embodiment, the generative AI model is deployed locally at the same data center as the server, using one or more graphics processing units or tensor processing units to accelerate matrix operations in the transformer network. In yet another embodiment, the server uses a smaller distilled model for low-latency applications, and a larger model only for complex inquiries that exceed a certain complexity threshold determined by heuristic or learned criteria.

The server may use alternative data storage architectures. In one embodiment, the server uses a relational database with normalized schemas, primary keys, and secondary indexes. In another embodiment, the server uses a combination of relational tables and key-value stores to quickly retrieve pre-aggregated summaries. The server may further use in-memory caches for frequently requested items, so that the server can respond to certain inquiries without executing disk-based queries. The generative AI model uses context about these storage structures in the prompt sentences, such that the analysis result information includes hints for which tables or keys to access.

The server, by combining pre-processing, generative AI analysis, structured query generation, verification, and caching, provides a technical architecture that improves processing speed, enhances accuracy, reduces erroneous queries, and decreases overall resource usage. The causal relationship is as follows: the explicit structured output from the generative AI model reduces ambiguity in mapping inquiries to data access patterns; the deterministic query construction uses indexes and parameterization to optimize database performance; the verification step using a specialized prompt sentence reduces logical errors in the final answer; and the modular design allows caching and re-use of intermediate results, which reduces repeated computation and network communication. As a result, the server improves the functioning of the computer system itself, rather than merely automating a known manual process.

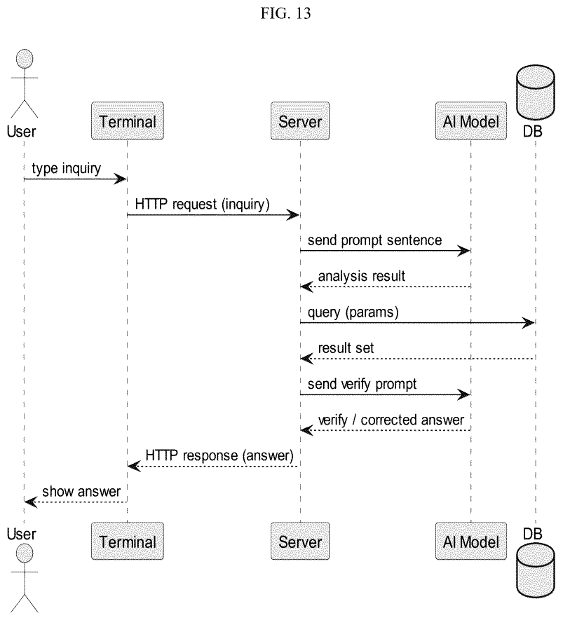

The following describes the processing flow using FIG. 13.
Step 1:

The user operates the terminal and inputs an inquiry as natural language text into an input field displayed by a browser application.

The input is a sequence of characters entered by the user, and the output is an inquiry text string held in a memory area of the terminal.

The terminal performs basic validation on the inquiry text, such as checking that the length is within a predetermined range and that prohibited characters are removed or escaped, thereby transforming raw key events into a sanitized text string.
Step 2:

The terminal constructs a request payload that includes the inquiry text together with metadata such as a store identifier, a user identifier, and a timestamp. The input is the sanitized inquiry text string and terminal-side metadata, and the output is a structured payload encoded, for example, as a key-value structure in memory. The terminal performs data formatting by concatenating the inquiry text and metadata into fields and then serializing the fields into an HTTP request body.
Step 3:

The terminal sends the HTTP request containing the structured payload to the server via a network interface using a transport protocol such as HTTPS. The input is the serialized request payload, and the output is a network packet stream transmitted over a communication path to the server. The terminal uses a network stack to segment the payload into packets, attaches protocol headers, and initiates a connection to the server's network address.
Step 4:

The server receives the HTTP request from the terminal by using web server software and passes the request to an application component for processing.

The input is the network packet stream representing the HTTP request, and the output is an in-memory representation of the request, including headers and body content.

The server reassembles the packets, parses the HTTP headers, and decodes the request body into internal data structures containing the inquiry text and metadata.
Step 5:

The server extracts the inquiry text and associated metadata from the request object and stores them in variables or records for subsequent processing.

The input is the in-memory HTTP request representation, and the output is a set of application-level variables, such as an inquiry text string, a store identifier, and a timestamp. The server performs data extraction operations by indexing into the request object, copying field values into typed variables, and optionally creating a log entry for traceability.
Step 6:

The server performs pre-processing of the inquiry text by applying a natural language processing technique such as tokenization, normalization, and language detection. The input is the raw inquiry text string, and the output is a token sequence and associated linguistic features stored in memory.

The server splits the text into tokens, converts characters to a normalized form, removes or flags stop-words, and computes features such as token positions and character n-grams to prepare the data for downstream analysis.
Step 7:

The server performs initial entity and keyword detection on the pre-processed tokens to identify candidate items such as product names, dates, and quantities.

The input is the token sequence and linguistic features, and the output is a list of candidate entities and keywords with associated positions and confidence scores.

The server applies statistical or dictionary-based matching, compares tokens against stored lists of known entities, and calculates similarity scores to mark tokens as potential parameters.
Step 8:

The server constructs a prompt sentence for a generative AI model that encodes both an instruction and the inquiry content, including placeholders for intent, products, date, and required fields.

The input is the inquiry text, the detected candidate entities, and a pre-defined instruction template, and the output is a complete prompt sentence as a character string.

The server performs string concatenation and template substitution by inserting the inquiry text and example output format into the template, thereby generating a structured instruction such as:
“You are an assistant that analyzes store inquiries.”

Analyze the intent of the following inquiry and extract the required data fields for a database query.

Output the result in the following format:
intent: [short description]
products: [comma-separated list]
date: [specific date expression or ‘none’]
needed_fields: [comma-separated list of field names]
Inquiry: “Please tell me today's stock status of Product A and Product B at store 001.”
Step 9:

The server sends the constructed prompt sentence to the generative AI model via an AI interface component that communicates with an external or internal AI service.

The input is the prompt sentence string and model configuration parameters such as model name, temperature, and maximum token count, and the output is an AI request message transmitted over a network or inter-process channel.

The server packages the prompt sentence together with parameters into a request payload, serializes it according to the AI service protocol, and transmits it via a secure channel such as HTTPS.
Step 10:

The server receives the response from the generative AI model and extracts the generated text that represents analysis result information.

The input is the AI response payload containing a generated text segment, and the output is a text block that describes intent, products, date, and needed fields.

The server parses the response format, selects the most relevant generated segment, and stores this segment as a single string in memory for further parsing.
Step 11:

The server parses the generated text from the generative AI model into structured analysis result information, such as an intent category, a list of product identifiers, a date value, and a list of required data fields.

The input is the generated text block, and the output is a structured object containing fields like “intent,” “products,” “date,” and “needed_fields.”

The server performs pattern matching and line-by-line parsing, splits the text at delimiters such as colons and commas, trims whitespace, and assigns parsed substrings to typed fields, optionally validating each field against known categories.
Step 12:

The server normalizes the structured analysis result information by mapping textual entities to internal identifiers and resolving date expressions.

The input is the structured analysis result object with textual product names and relative date expressions, and the output is a normalized parameter set with internal item identifiers and absolute date values.

The server uses a lookup table or database query to convert product names to product identifiers, uses the server clock to convert expressions such as “today” or “last week” into specific dates or date ranges, and converts lists into arrays suitable for query generation.
Step 13:

The server generates a database query expression that retrieves business information matching the normalized parameters, such as inventory or order status.

The input is the normalized parameter set including item identifiers, location identifiers, date values, and needed field names, and the output is a parameterized query expression suitable for a relational database engine.

The server constructs a query template, inserts table and column names, creates conditional clauses using the normalized parameters, and binds the parameters to placeholders, thereby transforming the structured parameters into a machine-readable retrieval instruction.
Step 14:

The server sends the query expression to an information management apparatus such as a relational database server and retrieves the target information that satisfies the inquiry conditions.

The input is the parameterized query expression and bound parameter values, and the output is a result set containing records that match the conditions.

The server opens a database connection, transmits the query over a database protocol, waits for the database engine to execute indexed searches and join operations, and then reads the returned rows into in-memory data structures.
Step 15:

The server aggregates and formats the target information into an intermediate representation suitable for answer generation, such as a list of items with associated attributes.

The input is the raw result set from the database, and the output is a normalized result object that groups data by item and computes any required aggregates.

The server iterates over the rows, converts each row into a structured record, groups records by key fields, and computes derived values such as total quantities or status flags, thereby performing data aggregation and transformation.
Step 16:

The server generates preliminary answer information in natural language based on the intermediate representation and the original intent information.

The input is the normalized result object and the intent field from the analysis result information, and the output is a draft answer text string that explains the result to the user.

The server uses a text template corresponding to the intent category, fills in variable parts such as product names and quantities, and concatenates sentences to form a coherent explanatory text.
Step 17:

The server constructs a verification prompt sentence that includes the preliminary answer information and a summary of relevant business rules and knowledge information. The input is the draft answer text, a set of business rules or knowledge snippets, and a verification instruction template, and the output is a verification prompt sentence string.

The server embeds the answer and the rules into the template and produces an instruction text such as:
“You are a verification assistant.”

Given the following answer and the following business rules, determine whether the answer conforms to the rules.

If the answer does not conform, briefly explain the problem and suggest a corrected answer.
Answer: [answer text]
Business rules: “[summary of rules].”
Step 18:

The server sends the verification prompt sentence to the generative AI model and receives a verification response that indicates whether the answer conforms to the prescribed information.

The input is the verification prompt sentence and AI model configuration parameters, and the output is a verification result text generated by the generative AI model. The server performs a similar transmission as in Step 9, then reads the returned text, which may contain a conformance flag, an explanation, and an alternative answer.
Step 19:

The server parses the verification result text and determines whether to keep, correct, or regenerate the answer information.

The input is the verification result text and the draft answer text, and the output is a final answer text that either matches the original or incorporates corrections.

The server searches for keywords or indicators such as “conforms,” “does not conform,” or explicit correction suggestions, applies rule-based logic to accept or reject corrections, and modifies the answer text accordingly.
Step 20:

The server optionally analyzes emotion information contained in the inquiry information or inferred in the analysis result information to adjust an expression style of the answer. The input is the inquiry text, the structured analysis result information, and optionally a separate emotion analysis output from the generative AI model, and the output is a tone-adjusted answer text.

The server selects a tone category such as neutral, urgent, or apologetic, and modifies wording by adding, removing, or changing phrases in the answer, while maintaining the factual content.
Step 21:

The server generates notification information that specifies how the answer should be transmitted to the user apparatus, including destination address, format, and transport method. The input is the final answer text and user or store metadata, and the output is a notification object containing fields for a recipient identifier, a channel type, and message content. The server determines whether to return the answer directly in the HTTP response, to send it via a message distribution apparatus, or to use both, and then populates the notification object with required routing information.
Step 22:

The server transmits the final answer information to the terminal by returning an HTTP response or by sending a message via a message distribution apparatus. The input is the notification object and the final answer text, and the output is a network packet stream carrying the answer to the terminal or to an associated message endpoint. The server serializes the notification object into a response body, sets appropriate headers or message attributes, and uses the network interface to send the response over a communication path.
Step 23:

The terminal receives the answer information from the server and decodes it into a displayable format.

The input is the network packet stream containing the response or message, and the output is a text string or structured data object representing the answer.

The terminal reassembles packets, parses protocol headers, and extracts the answer content, then stores the content in memory for rendering.
Step 24:

The terminal displays the final answer information to the user on a display device, optionally using a structured layout such as a table and a text explanation.

The input is the answer text and associated structured data, and the output is a rendered visual representation on the terminal screen.

The terminal updates the user interface by writing the text into view components, formatting numbers and dates, and, if applicable, highlighting key parts of the answer, thereby converting the internal data representation into human-readable output.
Step 25:

The user observes the displayed answer and, if necessary, initiates a follow-up inquiry by repeating the earlier steps.

The input is the visual representation of the answer as perceived by the user, and the output is a new inquiry text produced by the user's interaction with the terminal.

The user evaluates whether the answer satisfies the original intent, enters additional or refined questions using the input field, and triggers a new request cycle that the terminal and server process in the same manner.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional inquiry-handling systems that utilize natural language processing and simple routing logic often treat user messages as flat text directed to a single fixed workflow. Such systems typically perform only coarse intent detection and keyword extraction, then forward the inquiry to a predetermined service or department or generate a template-based response. As a result, these systems suffer from several technical limitations in their core information-processing pipeline.

First, the processor in conventional systems does not tightly integrate intent extraction, dynamic classification, prompt construction for a generative AI model, and answer verification into a coordinated sequence of machine operations. The natural language processing component may identify an intent, but the subsequent routing and response generation are usually hard-coded rules or static templates, so the system cannot flexibly adapt processing to nuanced combinations of intent, attributes, and downstream processing resources. This leads to inefficient utilization of computing resources, increased latency for complex inquiries, and brittle behavior when new services or document sets are added. Second, although generative AI models can produce natural language responses, conventional integrations simply pass the raw user text as input, without constructing structured prompt sentences that encode machine-interpretable context such as classified business function, processing domain, and user state. Without this structured context, the generative AI model operates in a largely unconstrained fashion, which increases the risk of irrelevant or inconsistent output and forces additional manual review. The absence of a systematic prompt-engineering layer tied to the upstream analysis results degrades answer quality and reduces the reliability of automatic response generation.

Third, existing systems generally lack a tight feedback loop that programmatically verifies whether generated responses conform to underlying document information or knowledge information (such as manuals, policies, or operational rules), and then automatically regenerates or corrects responses when non-conformity is detected. In many architectures, any checking is performed by human operators or simple pattern filters that are not structurally connected to the generative AI invocation. This separation causes inconsistent enforcement of constraints, increases the burden on downstream components, and limits end-to-end automation.

Fourth, most systems do not treat user emotion as a first-class input to the computational pipeline. Some platforms may log sentiment scores or display them in dashboards, but the core generation and adjustment of answer information are typically unaffected. As a consequence, the system does not algorithmically adapt the expression format or content of responses based on an automatically detected emotional state. This reduces the effectiveness of automated support, particularly when handling negative or sensitive inquiries, and forces human operators to intervene frequently.

Accordingly, there is a need for an improved computer-implemented system in which a processor: (i) receives inquiry information from a user terminal; (ii) extracts intent information and attribute information via natural language processing; (iii) automatically classifies the inquiry into a business function or processing domain and executes corresponding communications with external or internal processing resources; (iv) constructs a structured prompt sentence for a generative AI model based on the extracted and classified information; (v) verifies that answer information generated by the generative AI model conforms to document information or knowledge information and, if necessary, triggers correction or regeneration; and (vi) adjusts the expression format or content of the answer information based on an automatically detected emotional state of the user. By re-architecting the inquiry-handling pipeline in this way, the invention aims to improve the technical functioning of the computer system itself, including robustness, accuracy, resource utilization, and adaptability of automated response generation.

The specific processing by the specific processing unit 290 of the data processing device 12 in Application Example 2 is realized by the following means.

The present invention provides a server comprising a processor configured to receive inquiry information transmitted from a user terminal, extract intent information and attribute information from the inquiry information by using a natural language processing technique that analyzes human language, automatically classify the inquiry information into a business function or a processing domain based on the intent information and the attribute information, execute a communication process to an external processing resource or an internal processing resource according to a result of the classification, generate a prompt sentence to be input to a generative AI model that has been trained based on document information or operational rule information, the prompt sentence being generated in accordance with the intent information, the attribute information, and the classification result, input the prompt sentence into the generative AI model so as to cause the generative AI model to generate answer information, execute a consistency verification process on the answer information output from the generative AI model with respect to the document information or knowledge information, correct or regenerate the answer information based on a result of the consistency verification process, use an emotion estimation model that performs emotion analysis processing on text data and voice data of the inquiry information to identify an emotional state of a user, append the emotional state to the prompt sentence or otherwise condition the generative AI model based on the emotional state, and adjust an expression format or content of the answer information according to the emotional state and notify the adjusted answer information to the user terminal. This enables the computer system to implement an integrated, multi-stage inquiry-handling pipeline in which natural language understanding, automatic classification, prompt construction, constrained generative response, automatic conformity checking, and emotion-aware adjustment are executed as coordinated machine operations, thereby improving the accuracy, consistency, adaptability, and overall technical performance of automated response generation compared with conventional systems that lack such tightly coupled processing stages.

The term “inquiry information” refers to digital data representing a request, question, or instruction provided by a user, including at least text data and optionally voice data, that is received by the server from a user terminal for analysis and processing.

The term “user terminal” refers to an electronic device operated by a user, such as a computing device or a communication device, that is configured to transmit inquiry information to the server and receive answer information from the server.

The term “natural language processing technique” refers to a computational technique executed by the processor for analyzing human language text or speech, including at least tokenization, part-of-speech tagging, syntactic or semantic analysis, intent detection, or entity extraction.

The term “intent information” refers to data indicating a purpose, objective, or action requested by the user as inferred from the inquiry information by the natural language processing technique.

The term “attribute information” refers to data representing contextual or descriptive properties associated with the inquiry information, such as user information, product information, time information, location information, or any other metadata extracted from or linked to the inquiry information.

The term “business function” refers to a logical category of processing or service within an organization, such as order processing, support handling, information provision, or account management, to which an inquiry is assigned by the classification process.

The term “processing domain” refers to a technical or functional area of the system or associated systems, such as a subsystem, module, or external service, that performs specific processing corresponding to a classified inquiry.

The term “external processing resource” refers to a processing component, service, or system located outside the server, such as another server, an application programming interface, a database system, or a cloud service, which receives a communication process from the server to perform related operations.

The term “internal processing resource” refers to a processing component or module residing within the server or within a local system environment controlled by the server, such as an internal application, an internal database, or an internal processing module.

The term “communication process” refers to a sequence of operations in which the processor generates, transmits, receives, and processes digital messages or signals for interacting with an external processing resource or an internal processing resource through a communication interface.

The term “document information” refers to structured or unstructured data that describes rules, procedures, specifications, manuals, or other reference content, stored in a machine-readable form for use in training, constraining, or verifying output of the generative AI model.

The term “operational rule information” refers to information defining operational constraints, policies, guidelines, or business rules, which the processor uses to configure or limit behavior of the generative AI model and to verify answer information.

The term “knowledge information” refers to data representing accumulated facts, guidelines, or domain knowledge, including at least manuals, reference documents, or knowledge bases, that the processor refers to when checking consistency of answer information.

The term “generative AI model” refers to a machine learning model implementing a generative artificial intelligence function that receives a prompt sentence as input and generates answer information in natural language based on learned parameters.

The term “prompt sentence” refers to text data that encodes instructions, context, or constraints for the generative AI model, and that is constructed by the processor based on intent information, attribute information, classification results, and optionally emotional state.

The term “answer information” refers to response data generated by the generative AI model in accordance with a prompt sentence, including at least natural language text intended to be provided to the user in reply to the inquiry information.

The term “consistency verification process” refers to a process executed by the processor that compares answer information with document information or knowledge information using rule determination processing, pattern matching processing, or other comparison logic to determine whether the answer information conforms to predetermined constraints.

The term “rule determination processing” refers to processing that applies predefined logical rules, conditions, or constraints to digital data, such as answer information, to determine whether the data satisfies specified requirements.

The term “pattern matching processing” refers to processing that compares digital data, such as answer information, against patterns, templates, or regular expressions, to detect conformity or non-conformity with expected forms or contents.

The term “emotion estimation model” refers to a computational model or algorithm configured to receive at least text data and optionally voice data, and to output an estimated emotional state of the user based on emotion analysis processing.

The term “emotion analysis processing” refers to processing that extracts linguistic or acoustic features from the inquiry information and computes an emotional state, such as anger, anxiety, satisfaction, or neutrality, using the emotion estimation model.

The term “emotional state” refers to data representing a psychological state of the user, such as anger, joy, anxiety, confusion, or neutrality, as inferred from the inquiry information by the emotion estimation model.

The term “expression format” refers to stylistic properties of answer information, such as politeness level, tone, verbosity, or structure, which the processor adjusts according to the emotional state.

The term “classification result” refers to data indicating a business function or processing domain determined by the processor through automatic classification of the inquiry information based on intent information and attribute information.

The term “regeneration process” refers to processing in which the processor modifies at least a part of a prompt sentence and re-inputs the modified prompt sentence into the generative AI model so as to cause the generative AI model to newly generate answer information.

In one embodiment, a server implements the claimed system as a network-connected computing apparatus. The server includes at least one central processing unit (CPU), a main memory, a non-volatile storage device, a network interface, and optionally a graphics processing unit (GPU) or other hardware accelerator. The server executes an operating system such as a general-purpose server operating system, and executes one or more application programs that implement natural language processing, classification, prompt sentence generation, generative AI model inference, consistency verification, and emotion analysis.

Server stores inquiry information, document information, operational rule information, and knowledge information in one or more databases. The databases are embodied as a relational database management system or a document-oriented data store. Server manages structured records for each inquiry, including at least: an inquiry identifier, raw text of the inquiry, optional voice data or a reference to stored audio, user identifier, timestamp, and classification result. Server also stores document information and knowledge information as normalized text, which is obtained from manuals, policies, or guidelines. When the original documents are scanned or in image format, server uses an optical character recognition library, such as an open-source OCR engine, to convert the documents into machine-readable text before storing them. By keeping normalized text and indexed metadata, server can efficiently retrieve relevant document segments for later verification and training.

Terminal implements a user interface on a client device such as a smartphone, tablet, or personal computer. Terminal includes at least a processor, a display, an input device such as a touchscreen or keyboard, and optionally a microphone and speaker. Terminal executes an application or a browser-based client that collects inquiry information from a user, transmits the inquiry to server via a communication network, and displays answer information received from server. Terminal formats outgoing requests in a structured manner, for example including fields for text content, optional audio data, and user context, and uses a secure communication protocol such as HTTPS.

User operates terminal to input inquiry information, for example by typing a question such as “Can I return this product?” or speaking into the microphone to produce voice data. Terminal digitizes the voice data as an audio stream and may perform basic preprocessing such as compression or noise reduction. Terminal transmits the text data and/or audio data to server as part of an inquiry object.

Server receives the inquiry object via the network interface and stores it in memory for processing. Server applies a natural language processing technique to the textual portion of the inquiry information. In one embodiment, server uses a natural language processing library such as a statistical or neural parser to perform tokenization, part-of-speech tagging, and dependency parsing. Server converts each token into a numerical vector representation using word embeddings or contextual embeddings obtained from a pre-trained language model. Based on these feature vectors, server executes an intent classifier, for example a multi-layer neural network or a fine-tuned transformer model, to infer intent information from the inquiry text. Server also executes an entity recognizer to extract attribute information such as product names, quantities, dates, or locations. The combination of intent information and attribute information forms a structured representation of the user's request.

Server uses the structured representation as input to a classification module that assigns the inquiry to a business function or processing domain. In one embodiment, server uses a machine learning model trained on labeled inquiry data to map feature vectors derived from intent information and attribute information to a discrete domain label. The classification module may be implemented as a linear classifier, a support vector machine, or a small feed-forward neural network. This classification result is stored as part of the inquiry record and determines which internal or external processing resource should be contacted. For example, if the classification result corresponds to “returns processing,” server selects an internal returns subsystem or an external returns service as the processing resource.

Server executes a communication process toward the selected processing resource. When the processing resource is an internal module, server calls local application programming interfaces and issues data queries to internal databases using structured query statements. When the processing resource is external, server formats and transmits requests over an application-level protocol such as REST or message-queue-based messaging. Server receives structured responses from the processing resource, such as status codes, updated records, or parameters that must be reflected in the answer information. These interactions are integrated into the data flow and can modify or enrich the context used for subsequent generation of answer information.

Server generates a prompt sentence for a generative AI model by synthesizing the intent information, attribute information, classification result, and optionally the results from processing resources. Server constructs the prompt sentence as natural language text that encodes explicit instructions and constraints. For example, server can generate a prompt sentence such as:
“You are a support agent in the returns department. The user intends to request a product return. The product is identified in the records. Based on the official return manual, explain step by step how to return the product and obtain a refund. Include time limits, required documents, and shipping instructions. Use polite and reassuring language.”

In another example related to delivery delay, server can generate a prompt sentence such as:
“User question: ‘My last order still hasn't arrived. What is going on?’”
Detected user emotion: ‘anger’.

“You are a customer-support agent. Start with a sincere apology, acknowledge the user's frustration, and explain that you will check the order status and provide clear next steps. Use a very polite and empathetic tone.”

Server structures these prompt sentences using a defined template so that critical elements such as role, domain, constraints, and emotional state are always present in a consistent format. This structured prompt design ensures that the generative AI model receives clear conditioning signals, which improves answer stability and reduces variability.

In one embodiment, server implements the generative AI model as a neural network of the transformer type. Server stores model parameters and executes inference using a deep learning framework such as a tensor-based computation library. The transformer model includes multiple layers of self-attention and feed-forward sublayers. During training, server initializes the model from a pre-trained language model and fine-tunes the parameters on domain-specific text constructed from document information and knowledge information.

Server tokenizes the training text using a subword tokenizer and defines a sequence of tokens that represent both instructions and target responses. During fine-tuning, server computes a loss function such as cross-entropy loss between predicted token distributions and ground-truth tokens, and iteratively updates the model's weights using stochastic gradient descent or a variant thereof, such as Adam optimization. Server may also perform data augmentation, for example by paraphrasing instructions or varying question formulations, to improve robustness.

Server executes inference by encoding the prompt sentence into token indices, computing attention-based hidden states through the transformer layers, and successively decoding output tokens with a beam search or nucleus sampling algorithm. Server constrains the decoding procedure by limiting token types or enforcing termination based on punctuation rules, so that output answer information remains well-formed and within a desired length. Because the generative AI model operates on high-dimensional vectors and self-attention weights rather than explicit human rules, server achieves a non-linear mapping from prompt sentences to answer information that is different from simple rule-based response systems. Server performs a consistency verification process on the answer information generated by the generative AI model. For this purpose, server retrieves relevant sections of document information and knowledge information based on the intent information and attribute information. Server embeds both the answer information and the retrieved document segments using a vectorization function, and computes similarity scores to detect major discrepancies. Server also applies rule determination processing and pattern matching processing. For instance, if document information specifies a maximum return period of 30 days, server checks whether any numerical expressions in the answer information violate this constraint. Server uses regular expressions or finite-state pattern matchers to detect prohibited phrases or missing mandatory elements. When server detects non-conformity, server either corrects the answer information locally by modifying partial phrases, or regenerates the answer information by altering the prompt sentence, for example by adding a clause such as “Ensure that the answer strictly follows the 30-day return limit described in the manual.” This closed-loop correction process reduces factual errors and enforces alignment with stored knowledge.

Server further uses an emotion estimation model to analyze text data and voice data of the inquiry information. In one embodiment, server implements the emotion estimation model as a neural network that processes either text embeddings or acoustic feature vectors. For text, server uses a sequence classification head built on top of a transformer encoder, and trains the classifier on labeled emotional corpora. For audio, server extracts features such as Mel-frequency cepstral coefficients, pitch contours, and energy, and feeds them into a recurrent neural network or convolutional network. The emotion estimation model outputs probability scores across predefined emotional categories such as anger, anxiety, satisfaction, or neutrality. Server selects an emotional state based on the highest probability or a threshold rule. This emotion analysis processing constitutes a numerical signal processing step that adjusts internal parameters of the response pipeline.

Server uses the detected emotional state in at least two ways. First, server appends the emotional state to the prompt sentence or otherwise encodes it as an instruction, such as “Detected user emotion: anger. Respond with high politeness and explicit empathy.” Second, server adjusts the expression format of the answer information after generation, for example by inserting or strengthening apology phrases, simplifying technical explanations for confused users, or shortening responses for impatient users. These adjustments are performed according to rules stored in operational rule information and are applied syntactically to the generated text. As a result, server produces answer information whose tone and structure are dynamically adapted to user emotion without changing the factual constraints derived from document information.

Terminal receives the adjusted answer information from server and displays it in a user interface. Terminal can present the information as formatted text, and may additionally use a text-to-speech engine to convert the answer information into audio output, which is played through speakers. Terminal thus acts as the final interaction point between user and server, but does not perform the core decision or generation steps, which remain centralized for consistent control and optimization.

This architecture produces several technical effects that go beyond mere automation of human work. Because server decomposes the processing into well-defined stages intent extraction, classification, prompt sentence construction, constrained generative inference, verification, and emotion-aware adjustment server can optimize each stage for computational efficiency. For example, server can cache intermediate representations such as intent vectors and classification results, reducing repeated computations for similar inquiries. Server also minimizes network traffic to external processing resources by classifying inquiries accurately and only contacting relevant resources, which reduces communication load and latency. The structured prompt sentence design allows the generative AI model to converge to accurate responses with fewer decoding steps, thereby decreasing inference time and computational cost.

Moreover, by integrating automatic consistency verification and prompt-based regeneration, server reduces error rates compared with conventional systems that accept raw generative output. The use of explicit constraints derived from document information and knowledge information introduces a systematic correction loop that targets technical properties of the response such as numerical limits, required fields, and allowed operations. This loop improves reliability and reduces the need for human review.

Server's use of an emotion estimation model also creates a new technical behavior. Instead of simply logging sentiment, server converts the emotional state into structured control information that modifies the computational behavior of the prompt construction and post-processing modules. This results in a specific mapping from numerical emotion vectors to language generation parameters and template selection, which is independent of human decision-making and is implemented as repeatable machine operations. Through this mapping, server can reduce the number of follow-up inquiries and user corrections, which further saves processing cycles and bandwidth.

Alternative embodiments are also possible within the same inventive concept. Server may employ different natural language processing architectures, such as recurrent neural networks with attention instead of transformers, or may implement the classification module as a probabilistic graphical model. Server may host the generative AI model locally, or call a remote generative AI service through a network interface while still controlling prompt sentence structure and verification logic. Server may adjust the granularity of classification, for instance by using hierarchical labels where a top-level label identifies a general business function and a sub-label identifies a specific processing domain. Server may also vary the emotion categories or thresholding rules to accommodate particular application domains. In all embodiments, user operates terminal to supply inquiry information, terminal transmits the inquiry to server, and server executes the described data transformations and computations inside an integrated pipeline. Because the system uses particular data structures, specific neural network architectures, defined prompt sentence templates, and rule-based verification algorithms, the system achieves improved processing speed, accuracy, and consistency relative to generic conversational systems, and thereby improves the functioning of the underlying computer technology rather than merely replicating human reasoning.

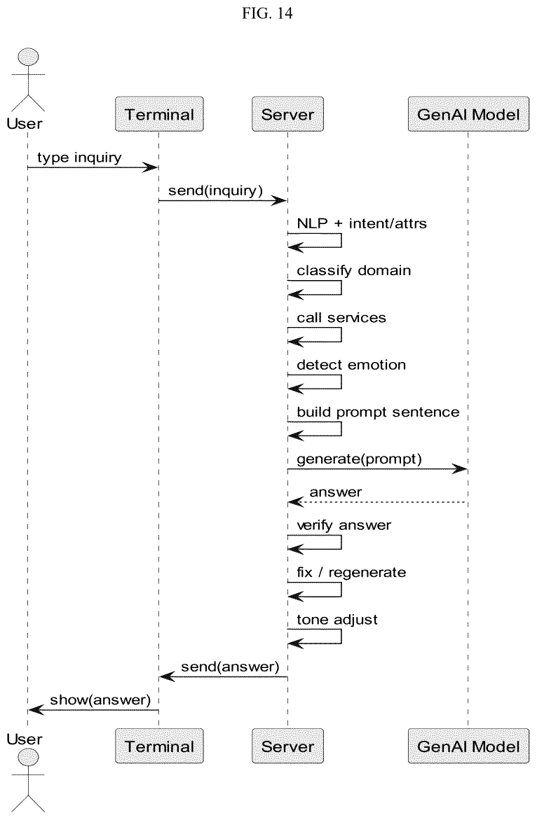

The following describes the processing flow using FIG. 14.
Step 1:

User operates the terminal to create inquiry information.

User inputs a question or request through a graphical user interface on the terminal, for example by typing “Can I return this product?” into a text field or by speaking into a microphone.

Input: Raw user interaction (keystrokes, touch events, voice).

Output: Structured inquiry object on the terminal, including at least text data (and optionally audio data), a user identifier, and a timestamp.

Terminal converts the raw interaction into a text string (and, if present, an audio file or stream), encapsulates these in a data structure (for example, a JSON-like object), and stores them temporarily in local memory.
Step 2:

Terminal transmits the inquiry information to the server.

Terminal packages the inquiry object together with device metadata and application version information, and sends it over a communication network using a secure protocol such as HTTPS.

Input: Inquiry object stored in terminal memory.

Output: Network message containing the inquiry object delivered to the server.

Terminal serializes the inquiry object into a byte stream, establishes a TCP/IP connection to a predefined server endpoint, and writes the serialized data to the network socket.
Step 3:

Server receives and stores the inquiry information.

Server obtains the incoming network message via the network interface, decodes the serialized data, and reconstructs the inquiry object.

Input: Network packet sequence representing the serialized inquiry object.

Output: Persistent inquiry record stored in a server-side database, including raw text, optional audio reference, user ID, and timestamp.

Server writes the reconstructed fields into a database table or document store with a generated inquiry identifier, which becomes the key for subsequent processing.
Step 4:

Server performs natural language preprocessing on the inquiry text.

Server retrieves the text field from the inquiry record and applies a natural language processing library to tokenize, normalize, and annotate the text.

Input: Raw text string of the inquiry.

Output: Token sequence with associated linguistic annotations such as part-of-speech tags and dependency relations.

Server splits the text into tokens (words or subwords), converts tokens to lower case where appropriate, removes extraneous whitespace, and invokes taggers and parsers to compute syntactic structures; server stores these annotations in memory as feature structures.
Step 5:

Server extracts intent information and attribute information.

Server feeds the preprocessed text or token embeddings into an intent classification model and an entity recognition model.

Input: Token sequence and linguistic features from the preprocessing step.

Output: Intent information (for example, “request_return”) and attribute information (for example, product identifier, order number, date).

Server converts tokens to numerical vectors using an embedding matrix, passes the vectors through a classifier network or transformer encoder, and computes a probability distribution over intent classes; server selects the highest-probability class as the intent. In parallel, server runs an entity recognizer over the token sequence, labels spans as domain-specific entities, and aggregates them into attribute records that are added to the inquiry record.
Step 6:

Server classifies the inquiry into a business function and processing domain.

Server uses the intent information and attribute information as features for a domain classification module.

Input: Intent label and attribute set derived from the inquiry.

Output: Classification result specifying a business function (for example, “returns”) and a processing domain (for example, “refund processing”).

Server encodes the intent as a one-hot vector, encodes attribute types into categorical features, concatenates these features, and applies a trained classifier (such as a linear model or small neural network) to compute domain scores; server selects the domain with the highest score and writes the classification result into the inquiry record.
Step 7:

Server optionally executes communication with internal or external processing resources.

Server determines, from the classification result, whether additional data or actions are required from subsystems, such as order databases or external services.

Input: Classification result, inquiry identifier, and attribute information.

Output: Updated context information including retrieved records (for example, order status, policy parameters).

Server constructs a request message containing necessary identifiers (for example, order ID) and sends it via an internal API call or an external HTTP request; server receives structured responses such as JSON objects, parses them, and merges key fields (for example, current shipping status or configured return period) into the inquiry context.
Step 8:

Server performs emotion analysis on the inquiry.

Server passes the text of the inquiry, and optionally features derived from audio, to an emotion estimation model.

Input: Inquiry text string and, if available, audio-derived acoustic features.

Output: Emotional state label (for example, anger, anxiety, neutrality) and associated confidence scores.

Server encodes the text as embeddings for a text-emotion classifier, computes logits for predefined emotion classes, applies a softmax function to obtain probabilities, and selects the highest-probability label. When audio is present, server extracts acoustic features (such as spectral coefficients) and processes them through an audio classifier, then combines text- and audio-based scores (for example, by weighted averaging) to produce the final emotional state.
Step 9:

Server constructs a structured prompt sentence for the generative AI model.

Server synthesizes the intent information, attribute information, classification result, retrieved context, and emotional state into a single instruction-style text string.

Input: Structured representation of the inquiry, including intent, attributes, domain label, context data, and emotional state.

Output: Prompt sentence in natural language that encodes role, task, constraints, and tone instructions for the generative AI model.

Server fills a template with variable slots, such as role (“You are a support agent in the returns department”), task (“explain step by step how to return the product”), constraints (“based on the official manual, obeying the 30-day limit”), and emotion (“Detected user emotion: anger; respond with high politeness and empathy”), then concatenates these segments into a coherent prompt sentence and stores it in memory.
Step 10:

Server executes inference of the generative AI model using the prompt sentence. Server tokenizes the prompt sentence using the tokenizer associated with the generative AI model and runs the tokens through the model.

Input: Prompt sentence text produced in the previous step.

Output: Generated answer information, represented initially as a sequence of output token IDs and then as a natural language text string.

Server maps prompt tokens to vocabulary indices, constructs an input tensor, and feeds it into a transformer-based generative AI model. The model computes self-attention weights and hidden states across multiple layers, and a decoder component outputs probability distributions over next-token candidates. Server uses a decoding algorithm such as beam search or nucleus sampling to select a sequence of tokens, stops generation when an end-of-sequence token is emitted or a length limit is reached, and converts the final token sequence back to text.
Step 11:

Server verifies consistency of the generated answer with document and knowledge information.

Server retrieves relevant document segments and compares them against the generated answer information.

Input: Generated answer text, document information, and knowledge information linked to the classified domain.

Output: Verification result indicating conformity or non-conformity, and optionally a list of detected discrepancies.

Server uses keyword and entity matching to identify document sections related to the same policies (for example, return period), converts both answer text and document excerpts into vector embeddings, and computes similarity scores; server also applies rule-based checks and pattern matching, such as regular expressions to validate numeric limits or required legal phrases. If any rule is violated or similarity scores fall below a threshold for critical segments, server marks the answer as non-conforming and identifies the conflicting parts.
Step 12:

Server corrects or regenerates the answer information when necessary.

Server uses the verification result to decide whether to adjust the current answer or to re-invoke the generative AI model with a modified prompt sentence.

Input: Generated answer text and verification result (conformity/non-conformity with details).

Output: Final corrected answer text that conforms to stored document and knowledge information.

Server may locally rewrite specific phrases (for example, replacing “60 days” with “30 days” when a rule limits the period), or may augment the prompt sentence with additional constraints such as “Ensure that the answer strictly follows the 30-day return limit” and re-run the generative AI model; server repeats the verification step if regeneration is performed, then stores the final, verified answer in association with the inquiry identifier.
Step 13:

Server adjusts the expression format and content based on the emotional state.

Server post-processes the verified answer text to match the tone and style specified by the emotional state.

Input: Verified answer text and emotional state label determined earlier.

Output: Adjusted answer text with modified politeness level, empathy, or complexity. Server applies tone-transformation rules, for example inserting an opening apology for anger, simplifying technical language for confusion, or adding reassurance phrases for anxiety; server may use template insertion, synonym replacement tables, or additional constrained calls to a language transformation module to effect these changes, and ensures that factual content remains unchanged.
Step 14:

Server transmits the final answer information to the terminal.

Server packages the adjusted answer text together with metadata such as inquiry identifier and timestamp, and sends it over the communication network.

Input: Adjusted answer text stored on the server.

Output: Network message containing answer information delivered to the terminal.

Server serializes the answer object, sets appropriate response headers, writes the data to the network socket associated with the terminal connection, and logs the transmission status.
Step 15:

Terminal receives and presents the answer information to the user.

Terminal obtains the network response from server, parses the payload, and extracts the answer text.

Input: Network response containing the final answer object.

Output: Displayed answer on the terminal screen and optionally audio output.

Terminal renders the answer text in a chat bubble or response panel, updates any status indicators for the inquiry, and, if configured, invokes a text-to-speech engine to synthesize audio playback through speakers; terminal then waits for further user interaction.
Step 16:

User reviews the answer information and decides on further actions.

User reads or listens to the response presented by terminal and determines whether the information is sufficient.

Input: Visual or auditory presentation of the adjusted answer text.

Output: User decision, such as ending the session, following the provided steps, or initiating a new or follow-up inquiry.

User may, for example, follow the described return procedure, or may enter an additional question, which will create a new inquiry object and return the flow to an earlier step.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

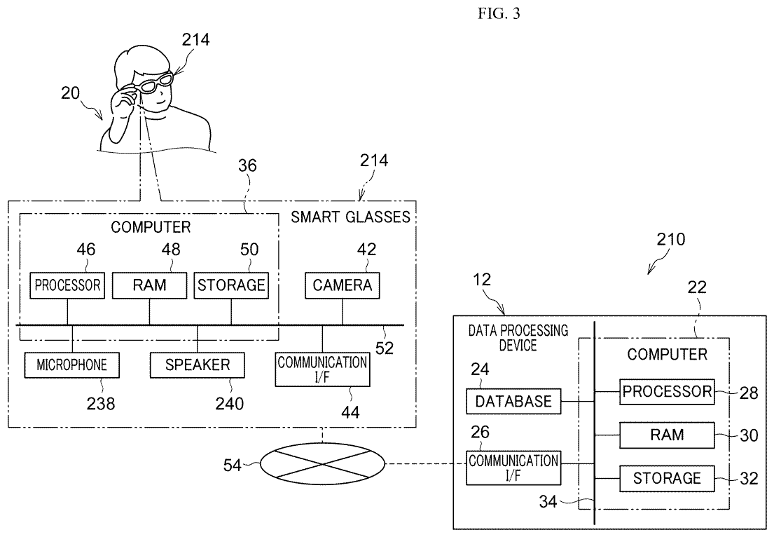

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

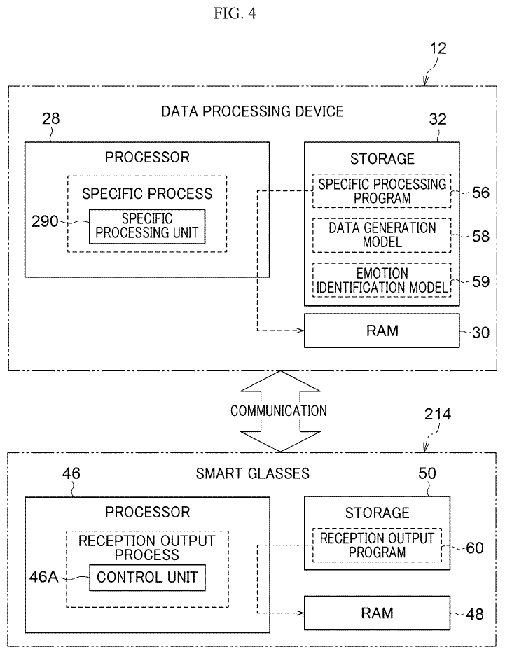

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

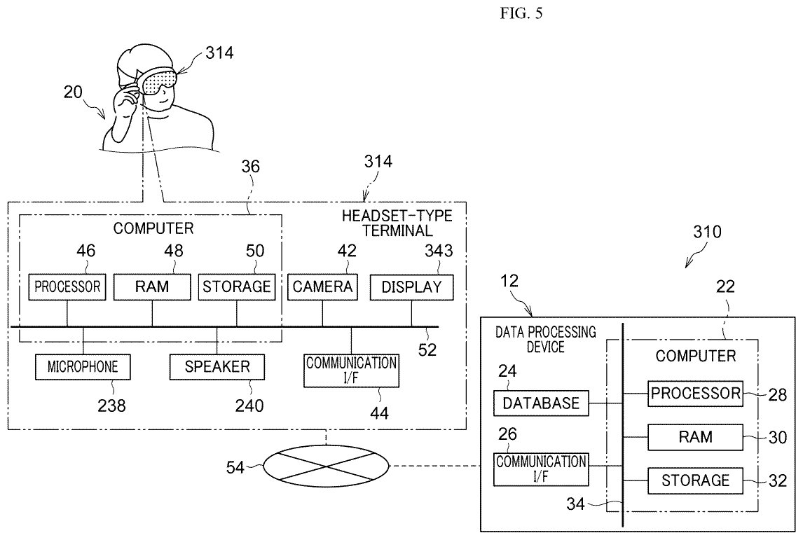

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

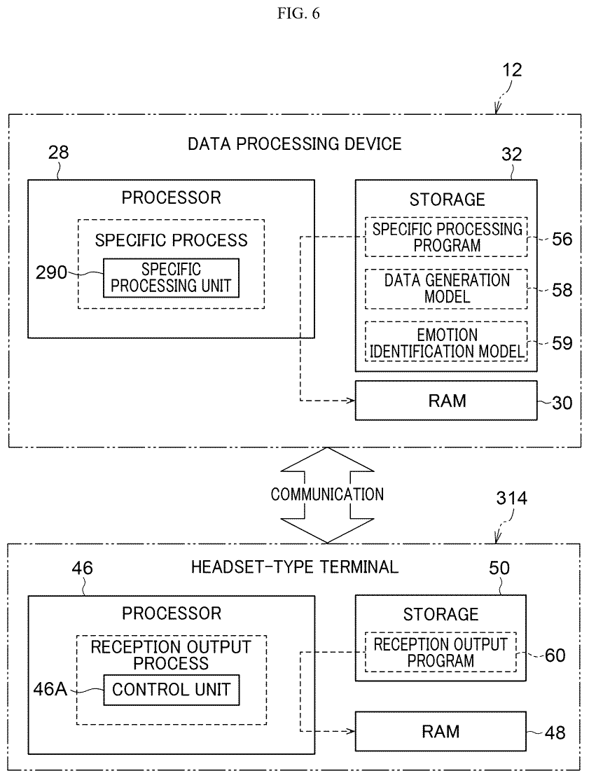

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

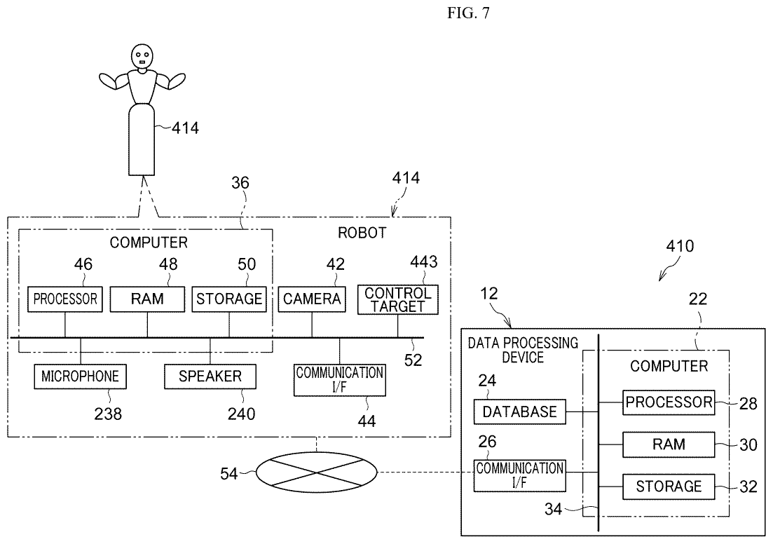

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

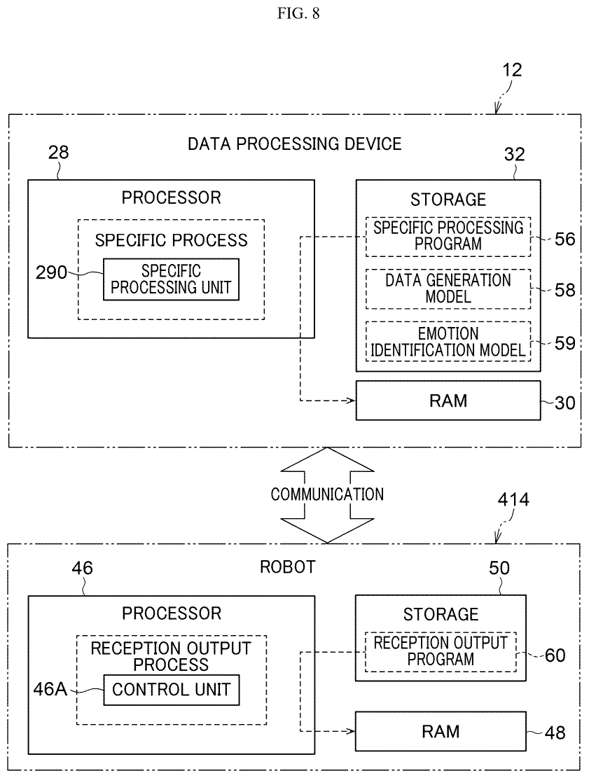

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

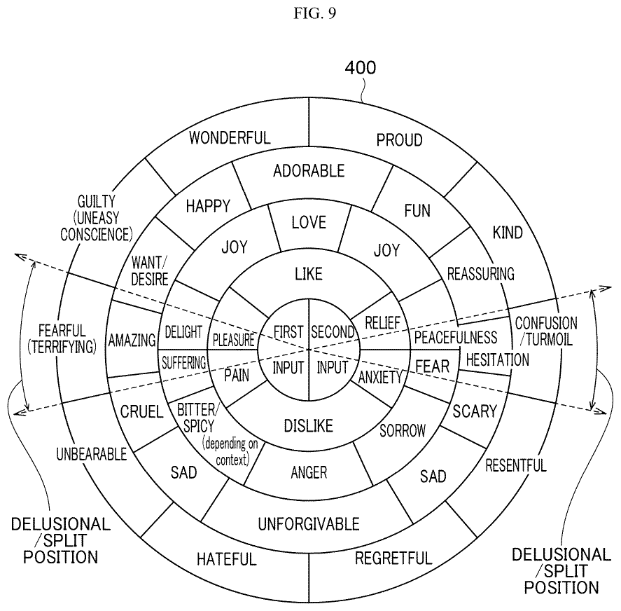

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

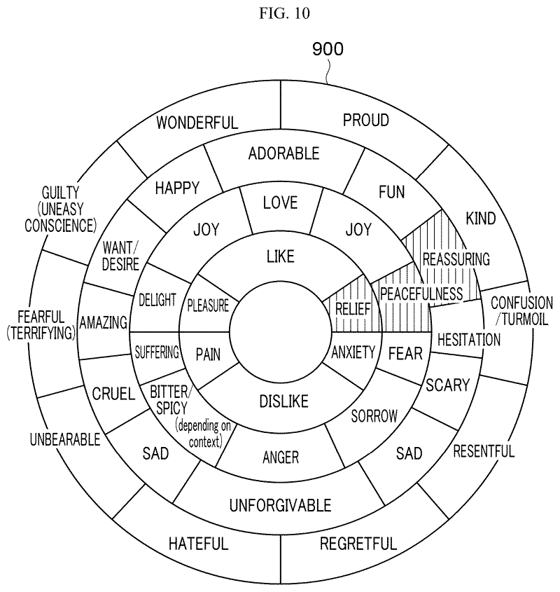

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a memory storing instructions, wherein the processor is configured to execute the instructions to receive inquiry information input by a user via a communication terminal through a communication network, and store the inquiry information as character information; perform language analysis processing on the character information by using natural language processing resources, the language analysis processing including morphological analysis, syntactic analysis, and semantic analysis, and extract purpose information and attribute information related to the inquiry information, and identify an inquiry type and a processing domain based on the purpose information and the attribute information; acquire, from a storage device, template information among a plurality of pieces of template information associated with the identified inquiry type and the processing domain, and embed the inquiry information and at least one of the extracted purpose information and the extracted attribute information into the template information to thereby construct a prompt sentence for input to a generative AI model;
add, to the prompt sentence, context information including related text information extracted from at least one of document information, explanation material, and rule information stored in a recording medium, and generate inquiry data including the prompt sentence and the context information as input information to be supplied to the generative AI model; transmit the inquiry data as a communication request to an external generative AI model providing apparatus, and receive answer candidate information output as a response from the generative AI model providing apparatus;
execute post-processing on the answer candidate information, the post-processing including at least one of deleting unnecessary information, formatting an expression style, and filtering prohibited terms, and generate final answer information corresponding to the inquiry information; and
transmit the final answer information as response data to the communication terminal through the communication network, and control display of the final answer information on the communication terminal.

### (Supplementary 2)

The system according to supplementary 1,
wherein the processor is configured to
acquire user characteristic information from the storage device, the user characteristic information being based on operation history information of the user and past inquiry information of the user, and add instruction information indicating at least one of an answer style, a detail level, and a use language, corresponding to the user characteristic information, to the prompt sentence, thereby adjusting an expression of a generated answer by the generative AI model.

### (Supplementary 3)

The system according to supplementary 1,
wherein the processor is configured to
associate identification information of at least one of the document information, the explanation material, and the rule information used for generation of the answer candidate information with the final answer information, and record the final answer information in association with the identification information, thereby enabling tracking of basis information referenced by the final answer information.

### Application Example 1

### (Supplementary 1)

A system comprising a processor,
wherein the processor is configured to
receive, via a communication network, inquiry data expressed in natural language and transmitted from an information terminal that accepts operations of a user, and convert the inquiry data into a structured internal representation,
generate a prompt sentence to be input to a generative AI model on the basis of the inquiry data and the internal representation, and transmit a request including the prompt sentence to an external chatbot-generation information processing function,
receive, from the chatbot-generation information processing function, response data including a response text generated on the basis of the prompt sentence,
acquire, from an information storage mechanism that stores knowledge information describing operational rules of an organization, knowledge information related to the inquiry data, and compare the response text with the knowledge information to evaluate whether the response text is consistent with the knowledge information,
when, based on a result of the evaluation, it is determined that the response text is inconsistent with the knowledge information, newly generate a correction prompt sentence including the knowledge information, re-input the correction prompt sentence to the generative AI model, and obtain a corrected response text, and
convert at least one of the response text and the corrected response text into display data transmittable to the information terminal, and provide the display data to the user in real time via the information terminal.

### (Supplementary 2)

The system according to supplementary 1,
wherein the processor is configured to estimate an emotional state with respect to the inquiry data from the user, and change a style of expression of at least one of the prompt sentence and the response text in accordance with the estimated emotional state.

### (Supplementary 3)

The system according to supplementary 1,
wherein the processor is configured to store, as history information, a generation history of at least one of the response text and the corrected response text, the knowledge information used, and the prompt sentence in association with one another, and update generation conditions for the prompt sentence to be input to the generative AI model on the basis of the history information.

### Example 2

### (Supplementary 1)

A system comprising a processor,
wherein the processor is configured to
receive inquiry information from a user apparatus via a communication scheme, and analyze the inquiry information by using a natural language processing technique to extract intent information and request information included in the inquiry information,
generate a prompt sentence as inquiry-processing generation information on the basis of the intent information and the request information, input the prompt sentence to a generative information processing apparatus, and obtain analysis result information or answer candidate information from the generative information processing apparatus,
generate a query expression for searching business information stored in a storage apparatus in accordance with inquiry conditions on the basis of the analysis result information, and obtain target information from an information management apparatus by using the query expression,
generate answer information as processing result information for the inquiry on the basis of the target information and the analysis result information, and generate notification information for providing the answer information to the user apparatus, and
transmit the answer information automatically by using the notification information via a message distribution apparatus or a communication path, and cause the user apparatus to present the answer information.

### (Supplementary 2)

The system according to supplementary 1,
wherein the processor is configured to estimate emotion information included in the inquiry information on the basis of the analysis result information, and adjust an expression style or content of the answer information in accordance with the emotion information.

### (Supplementary 3)

The system according to supplementary 1,
wherein the processor is configured to determine whether or not the answer information conforms to prescribed information including business rule information or knowledge information by using a verification prompt sentence for the generative information processing apparatus or a rule determination process, and to correct or regenerate the answer information in accordance with a determination result.

### Application Example 2

### (Supplementary 1)

A system comprising a processor,
wherein the processor is configured to
receive inquiry information transmitted from a user terminal and extract intent information and attribute information from the inquiry information by using a natural language processing technique that analyzes human language,
automatically classify the inquiry information into a business function or a processing domain based on the intent information and the attribute information, and execute a communication process to an external processing resource or an internal processing resource according to a result of the classification,
generate a prompt sentence to be input to a generative AI model that has been trained based on document information or operational rule information, the prompt sentence being generated in accordance with the intent information, the attribute information, and the classification result, and input the prompt sentence into the generative AI model so as to cause the generative AI model to generate answer information,
execute a consistency verification process on the answer information output from the generative AI model with respect to the document information or knowledge information, and correct or regenerate the answer information based on a result of the consistency verification process, and
adjust an expression format or content of the answer information according to a detected emotional state of a user and notify the adjusted answer information to the user terminal.

### (Supplementary 2)

The system according to supplementary 1,
wherein the processor is configured to
use an emotion estimation model that performs emotion analysis processing on text data and voice data of the inquiry information to identify the emotional state of the user, and append the emotional state to the prompt sentence so as to control the generative AI model to generate a response sentence corresponding to the emotional state.

### (Supplementary 3)

The system according to supplementary 1,
wherein the processor is configured to verify whether the answer information generated by the generative AI model conforms to constraint conditions and operational criteria described in the document information or the knowledge information by rule determination processing or pattern matching processing, and, when nonconformity is detected, change content of the prompt sentence and execute a regeneration process by the generative AI model.

What is claimed is:

1. A system comprising:
circuitry configured to:
receive, via a communication interface coupled to a packet-switched network, inquiry information input by a user from a terminal device, and store the inquiry information as character information in a storage device;
perform language analysis processing on the character information using natural language processing resources, the language analysis processing comprising morphological analysis, syntactic analysis, and semantic analysis, to extract purpose information and attribute information related to the inquiry information, and identify an inquiry type and a processing domain based on the purpose information and the attribute information;
acquire template information associated with the identified inquiry type and the processing domain from the storage device, and embed the inquiry information and at least one of the extracted purpose information and the extracted attribute information into the template information to construct a prompt sentence for input to a generative AI model;
add constraint condition information and domain-specific knowledge information to the prompt sentence, input the prompt sentence to the generative AI model to obtain answer information, and verify whether the answer information conforms to the constraint conditions by rule determination processing or pattern matching processing; and
transmit the verified answer information to the terminal device via the communication interface.

2. The system according to claim 1, wherein the circuitry is configured to perform emotion analysis processing on text data and voice data of the inquiry information to identify an emotional state of the user, and append the emotional state as a conditioning parameter to the prompt sentence to control the generative AI model to generate answer information corresponding to the emotional state.

3. The system according to claim 2, wherein the circuitry is configured to apply a prosody analysis model to voice data received from the terminal device to extract pitch contours and energy features, apply a sentiment analysis model to the text data to generate a sentiment score, and combine the prosodic features and the sentiment score to generate the emotional state representation.

4. The system according to claim 3, wherein the circuitry is configured to adjust the answer information based on the emotional state representation by selecting a tone parameter and a detail level parameter, and incorporate the tone parameter and the detail level parameter into the prompt sentence prior to input to the generative AI model.

5. The system according to claim 4, wherein the circuitry is configured to apply a complaint detection model to the inquiry information to identify high-urgency inquiry items, and assign high-priority routing parameters to high-urgency items for expedited processing.

6. The system according to claim 1, wherein the circuitry is configured to when nonconformity is detected by the rule determination processing or pattern matching processing, change content of the prompt sentence and execute a regeneration process using the generative AI model to obtain corrected answer information.

7. The system according to claim 6, wherein the circuitry is configured to apply a consistency verification model to the corrected answer information to confirm that the corrected content conforms to the constraint conditions, and repeat the regeneration process until conformity is verified or a maximum iteration count is reached.

8. The system according to claim 1, wherein the circuitry is configured to apply a routing model to the identified inquiry type and the processing domain to automatically route the inquiry information to a designated processing unit, and store a routing decision record in the storage device.

9. The system according to claim 8, wherein the circuitry is configured to apply a load balancing algorithm to routing decisions to distribute inquiry information across a plurality of processing units based on current processing capacity metrics stored in the storage device.

10. The system according to claim 1, wherein the circuitry is configured to apply a named entity recognition model to the character information to extract entity types relevant to the processing domain, and use the extracted entity types as additional parameters in the template information embedding.

11. The system according to claim 10, wherein the circuitry is configured to apply a co-reference resolution model to the character information to resolve pronoun references and identify antecedent entities, and update the extracted attribute information based on the resolved references.

12. The system according to claim 1, wherein the circuitry is configured to apply a knowledge retrieval model to retrieve relevant sections from knowledge information stored in the storage device based on the identified inquiry type and purpose information, and incorporate the retrieved sections into the prompt sentence as contextual reference information.

13. The system according to claim 12, wherein the circuitry is configured to apply a relevance scoring model to rank retrieved knowledge sections by alignment with the purpose information, and include only the highest-ranked sections in the prompt sentence to control prompt length.

14. The system according to claim 1, wherein the circuitry is configured to accumulate inquiry information, prompt sentences, answer information, and routing decisions in the storage device, and apply a pattern analysis model to the accumulated data to update template information and routing model parameters.

15. The system according to claim 14, wherein the circuitry is configured to apply a clustering algorithm to accumulated inquiry information to identify recurring inquiry categories, and generate new template information for identified recurring categories to improve prompt sentence construction efficiency.

16. The system according to claim 1, wherein the circuitry is configured to receive multi-turn inquiry information from the terminal device, maintain a dialog context across multiple turns, and incorporate the dialog context in the prompt sentence for each subsequent turn.

17. The system according to claim 16, wherein the circuitry is configured to apply a context summarization model to the dialog context at the end of each turn to generate a compact context representation, and use the compact context representation in subsequent prompt sentences to manage context length.

18. A system comprising:
circuitry configured to:
receive, via a communication interface coupled to a packet-switched network, inquiry information from a terminal device, store the inquiry information as character information, and perform language analysis processing comprising morphological analysis, syntactic analysis, and semantic analysis to extract purpose information, attribute information, an inquiry type, and a processing domain;
acquire template information associated with the inquiry type and processing domain, embed the inquiry information and extracted attributes into the template information, add constraint condition information and knowledge information, and construct a prompt sentence for a generative AI model;
perform emotion analysis processing on text data and voice data of the inquiry information to generate an emotional state representation, and append the emotional state representation as a conditioning parameter to the prompt sentence;
input the prompt sentence to the generative AI model to obtain answer information, verify conformity with constraint conditions using rule determination processing, and when nonconformity is detected change the prompt sentence and execute a regeneration process; and
transmit the verified answer information to the terminal device via the communication interface.

19. The system according to claim 18, wherein the circuitry is configured to accumulate inquiry information, prompt sentences, and answer information in the storage device, apply a pattern analysis model to identify recurring inquiry categories, generate new template information for recurring categories, and update routing model parameters based on accumulated routing decisions.

20. A method comprising:
receiving, via a communication interface coupled to a packet-switched network, inquiry information input by a user from a terminal device, and storing the inquiry information as character information in a storage device;
performing language analysis processing on the character information using natural language processing resources, the language analysis processing comprising morphological analysis, syntactic analysis, and semantic analysis, to extract purpose information and attribute information related to the inquiry information, and identifying an inquiry type and a processing domain based on the purpose information and the attribute information;
acquiring template information associated with the identified inquiry type and the processing domain from the storage device, and embedding the inquiry information and at least one of the extracted purpose information and the extracted attribute information into the template information to construct a prompt sentence for input to a generative AI model;
adding constraint condition information and domain-specific knowledge information to the prompt sentence, inputting the prompt sentence to the generative AI model to obtain answer information, and verifying whether the answer information conforms to the constraint conditions by rule determination processing or pattern matching processing; and
transmitting the verified answer information to the terminal device via the communication interface.
